(19) United States
(12) Patent Application Publication
(10) Pub. No.: US 2025/0029384 A1
(43) Pub. Date: Jan. 23, 2025

(54) METHOD PERFORMED BY ELECTRONIC APPARATUS, ELECTRONIC APPARATUS AND STORAGE MEDIUM FOR INPAINTING

(71) Applicant: SAMSUNG ELECTRONICS CO., LTD., Suwon-si (KR)

(72) Inventors: Xiansong SONG, Beijing (CN); Lei CAO, Beijing (CN); Donghan YANG, Beijing (CN); Mengmeng BAI, Beijing (CN); Jaekeun NA, Suwon-si (KR); Li ZUO, Beijing (CN)

(73) Assignee: SAMSUNG ELECTRONICS CO., LTD., Suwon-si (KR)

(21) Appl. No.: 18/665,169

(22) Filed: May 15, 2024

Related U.S. Application Data
(63) Continuation of application No. PCT/KR2024/005138, filed on Apr. 17, 2024.

(30) Foreign Application Priority Data
Jul. 21, 2023 (CN) 202310901652.1

(51) Int. Cl. G06V 20/40; G06T 5/77

(52) U.S. Cl. CPC G06V 20/46; G06T 5/77

(57) ABSTRACT

According to an embodiment of the disclosure, a method performed by an electronic apparatus may include extracting at least one key frame and at least one non-key frame from a video. According to an embodiment of the disclosure, a method performed by an electronic apparatus may include inpainting the at least one key frame based on at least one mask corresponding to the at least one key frame. According to an embodiment of the disclosure, a method performed by an electronic apparatus may include inpainting the at least one non-key frame based on the at least one inpainted key frame.

### CROSS-REFERENCE TO RELATED APPLICATIONS

This application is a continuation application of International Application No. PCT/KR2024/005138 designating the United States, filed on Apr. 17, 2024, in the Korean Intellectual Property Receiving Office and claiming priority to Chinese Patent Application No. 202310901652.1, filed on Jul. 21, 2023, in the China National Intellectual Property Administration, the disclosures of which are incorporated by reference herein in their entireties.

### BACKGROUND

### 1. Field

The disclosure relates to a field of video processing, and in particular, to a method performed by an electronic apparatus, an electronic apparatus and a storage medium.

### 2. Description of Related Art

In many video application scenarios, there are technical requirements for removing an object in frames of a video and complementing a missing area in the frames. In particular, with the popularity of a mobile terminal such as a smart phone, a tablet computer, and so on, a demand for people to use the mobile terminal for video capturing and video processing is increasing gradually. However, in the related art, a technique such as removal of the object in the frames or complement of the missing area in the frames has a low efficiency, an excessive resource waste, a slow processing speed, a difficulty in processing a long video or an unstable complement effect.

How to efficiently remove the object or complement the missing area to better satisfy the user requirements is a technical problem that those skilled in the art are working hard to study.

### SUMMARY

According to an embodiment of the disclosure, a method performed by an electronic apparatus may include extracting at least one key frame and at least one non-key frame from a video. According to an embodiment of the disclosure, a method performed by an electronic apparatus may include inpainting the at least one key frame based on at least one mask corresponding to the at least one key frame. According to an embodiment of the disclosure, a method performed by an electronic apparatus may include inpainting the at least one non-key frame based on the at least one inpainted key frame.

According to an embodiment of the disclosure, an electronic apparatus may include at least one processor, and at least one memory storing computer executable instructions that, when executed by the at least one processor. According to an embodiment of the disclosure, at least one processor may be configured to extract at least one key frame and at least one non-key frame from a video. According to an embodiment of the disclosure, at least one processor may be configured to inpaint the at least one key frame based on at least one mask corresponding to the at least one key frame. According to an embodiment of the disclosure, at least one processor may be configured to inpaint the at least one non-key frame based on the at least one inpainted key frame.

According to an embodiment of the disclosure, a non-transitory computer readable storage medium storing instructions that, when executed by at least one processor, cause the at least one processor to perform the method is provided. According to an embodiment of the disclosure, at least one processor may be configured to extract at least one key frame and at least one non-key frame from a video. According to an embodiment of the disclosure, at least one processor may be configured to inpaint the at least one key frame based on at least one mask corresponding to the at least one key frame. According to an embodiment of the disclosure, at least one processor may be configured to inpaint the at least one non-key frame based on the at least one inpainted key frame.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart showing a method performed by an electronic apparatus according to an embodiment of the disclosure;

FIG. 2 is a process schematic diagram illustrating a method performed by an electronic apparatus according to an embodiment of the disclosure;

FIG. 3 illustrates a decoding schematic diagram;

FIG. 4 is a schematic diagram illustrating a distribution condition of I-frames, P-frames and B-frames;

FIG. 5 is a process schematic diagram illustrating a method performed by an electronic apparatus according to an embodiment of the disclosure;

FIG. 6 is a process schematic diagram illustrating a method performed by an electronic apparatus according to an embodiment of the disclosure;

FIG. 7 is a flowchart illustrating a process of inpainting a group of key frames according to an embodiment of the disclosure;

FIG. 8 is a schematic diagram illustrating a processing of a spatial-temporal memory Transformer module according to an embodiment of the disclosure;

FIG. 9 is a flowchart illustrating a process of processing a feature of a group of key frames based on a feature of inpainted key frames according to an embodiment of the disclosure;

FIG. 10 is a process schematic diagram illustrating a processing of a memory reading module according to an embodiment of the disclosure;

FIG. 11 is a schematic diagram illustrating updating of a spatial-temporal memory according to an embodiment of the disclosure;

FIG. 12 is a block diagram illustrating a short term memory update module according to an embodiment of the disclosure;

FIG. 13 is a flowchart illustrating a process for extracting a third feature according to an embodiment of the disclosure;

FIG. 14 is a block diagram illustrating a long term memory update module according to an embodiment of the disclosure;

FIG. 15 is a schematic diagram illustrating a process for inpainting a non-key frame according to an embodiment of the disclosure;

FIG. 16 is a schematic diagram illustrating a process for inpainting a non-key frame according to an embodiment of the disclosure;

FIG. 17 is a schematic diagram illustrating a structure of an alignment module according to an embodiment of the disclosure;

FIG. 18 is a schematic diagram illustrating a process for inpainting a non-key frame according to an embodiment of the disclosure;

FIG. 19 is a flowchart illustrating a process of obtaining one aligned first key frame based on motion vector information of a current non-key frame relative to one first key frame, according to an embodiment of the disclosure;

FIG. 20 is a flowchart illustrating a process of inpainting a current non-key frame based on at least one aligned first key frame according to an embodiment of the disclosure;

FIG. 21A is a flowchart illustrating a process of fusing a thirteenth feature and at least one fourteenth feature of at least one aligned first key frame to obtain a fifteenth feature of a current non-key frame according to an embodiment of the disclosure;

FIG. 21B is a process schematic diagram illustrating a processing of a temporal attention fusion module according to an embodiment of the disclosure;

FIG. 22 is a schematic diagram illustrating temporal location information according to an embodiment of the disclosure;

FIG. 23 is a process schematic diagram illustrating a processing of a temporal attention fusion module according to an embodiment of the disclosure;

FIG. 24 is a flowchart illustrating a method performed by an electronic apparatus according to an embodiment of the disclosure;

FIG. 25A is a flowchart illustrating one example of applying a method performed by an electronic apparatus according to an embodiment of the disclosure;

FIG. 25B is a flowchart illustrating another example of applying a method performed by an electronic apparatus according to an embodiment of the disclosure; and

FIG. 26 is a block diagram illustrating an electronic apparatus according to an embodiment of the disclosure.

### DETAILED DESCRIPTION

Embodiments of the disclosure are described below in conjunction with the accompanying drawings in the present application. It should be understood that the embodiments described below in combination with the accompanying drawings are examples for explaining technical solutions of the embodiments of the present application, and do not constitute limitations on the technical solutions of the embodiments of the present application.

It may be understood by those skilled in the art that, singular forms “a”, “an”, “the” and “this” used herein may also include plural forms, unless specifically stated. It should be further understood that, terms “include/including” and “comprise/comprising” used in the embodiments of the present application mean that a corresponding feature may be implemented as the presented feature, information, data, step, operation, element, and/or component, but do not exclude implement of other features, information, data, steps, operations, elements, components and/or a combination thereof, which are supported in the present technical field. It should be understood that, when we state that one element is “connected” or “coupled” to another element, the one element may be directly connected or coupled to the another element, or it may mean that a connection relationship between the one element and the another element is established through an intermediate element. In addition, “connect” or “couple” used herein may include a wireless connection or wireless coupling. The term “and/or” used herein represents at least one of items defined by this term, for example, “A and/or B” may be implemented as “A”, or as “B”, or as “A and B”. When a plurality of (two or more) items are described, if a relationship between the plurality of items is not clearly defined, “between the plurality of items” may refer to one, some or all of the plurality of items. For example, for a description “a parameter A includes A1, A2, A3”, it may be implemented that the parameter A includes A1, or A2, or A3, and it may also be implemented that the parameter A includes at least two of the three parameters A1, A2, A3.

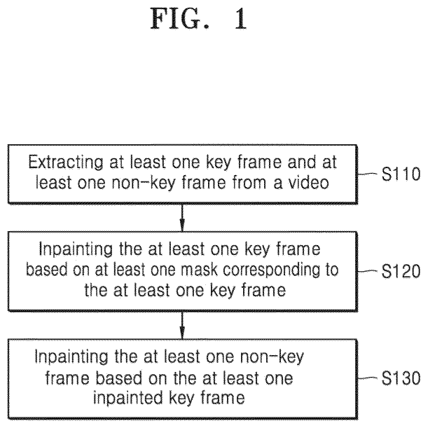

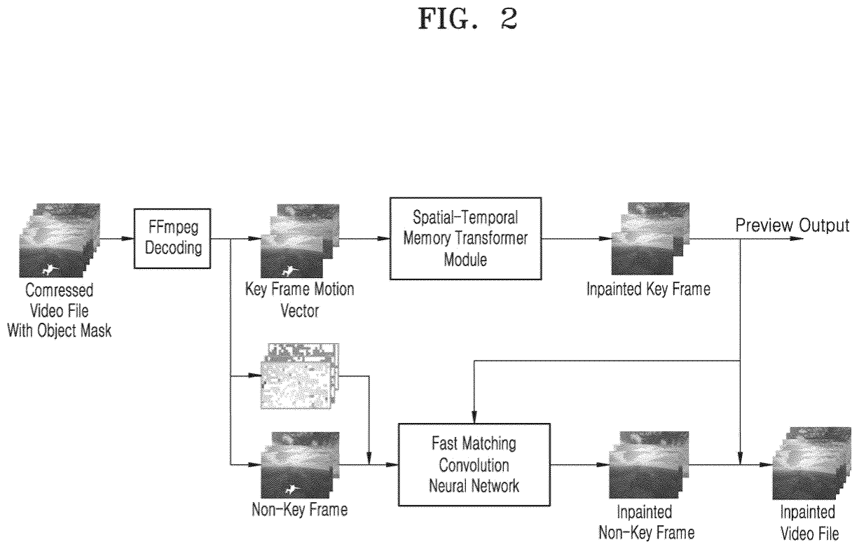

FIG. 1 is a flowchart illustrating a method performed by an electronic apparatus according to an embodiment of the disclosure. FIG. 2 is a process diagram illustrating a method performed by an electronic apparatus according to an embodiment of the disclosure.

At step S110, at least one key frame and at least one non-key frame are extracted from a video.

In an embodiment of the disclosure, the video in step S110 may be obtained by decoding a compressed video file with a mask by a decoder. The extracting the at least one key frame and the at least one non-key frame from the video may include extracting the at least one key frame and the at least one non-key frame from the video according to decoding information of the video. In an embodiment of the disclosure, an intra-coded (e.g., referred to as I for short) frame (e.g., I-frame) and/or a forward predictive coded (e.g., referred to as P for short) frame (e.g., P-frame) may be extracted as the at least one key frame, and a bi-directional interpolated prediction (e.g., referred to as B for short) frame (e.g., B-frame) is extracted as the at least one non-key frame. In addition, when the at least one non-key frame is extracted from the video, motion vector information of the at least one non-key frame may also be obtained from the decoding information of the video.

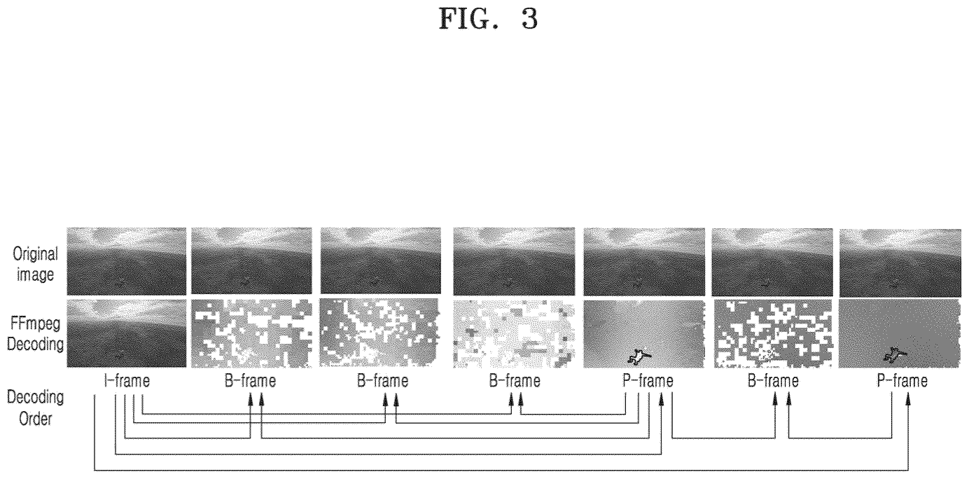

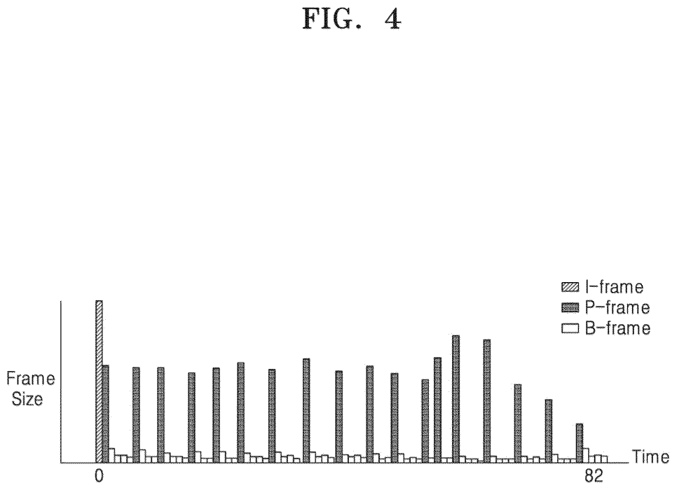

As shown in FIG. 2, the compressed video file with the mask is firstly decoded by a video decoder which may support various video coding and decoding standards, such as MPEG4, H.264, HEVC, etc., and the video decoder may be, for example, an FFmpeg decoder, but the present application is not limited thereto. After decoding, extraction of the key frame and the non-key frame may be performed on the decoded video according to the decoding information of the video, and simultaneously, the motion vector information of each non-key frame may be obtained based on the decoding information of the video. For example, FIG. 3 illustrates one schematic diagram of decoding the video. In FIG. 3, three types of frames, e.g., a I-frame, a P-frame, and a B-frame, may be extracted when decoding a compressed video using a video decoder (e.g., an FFmpeg decoder), wherein the I-frame may retain complete information of the original image, the P-frame may retain motion vector information relative to the I-frame, and the B-frame may retain motion vector information relative to the I-frame and the P-frame. Since the I-frame and the P-frame may contain a large amount of useful information, and the B-frame may contain a large amount of redundant or repetitive information, the I-frame and the P-frame may be classed as the key frames and the B-frame may be classed as the non-key frame in an embodiment of the disclosure. In addition, that coding the same video using different video coding and decoding standards may result in different proportions of I-frames, P-frames, and B-frames. For example, FIG. 4 illustrates a distribution condition of I-frames, P-frames, and B-frames in a video coded using a H.264 standard, wherein proportions of the I-frames and the P-frames (e.g., the key-frames) are about 20%˜30%, and the proportion of the B-frames (e.g., the non-key-frames) are about 76.8%. However, this is only an example, and the embodiment of the disclosure may employ various video coding and decoding standards to decode a video encoded in accordance with the corresponding standard, and accordingly extracts the I-frame and/or P-frame as the key frame and extracts the B-frame as the non-key frame.

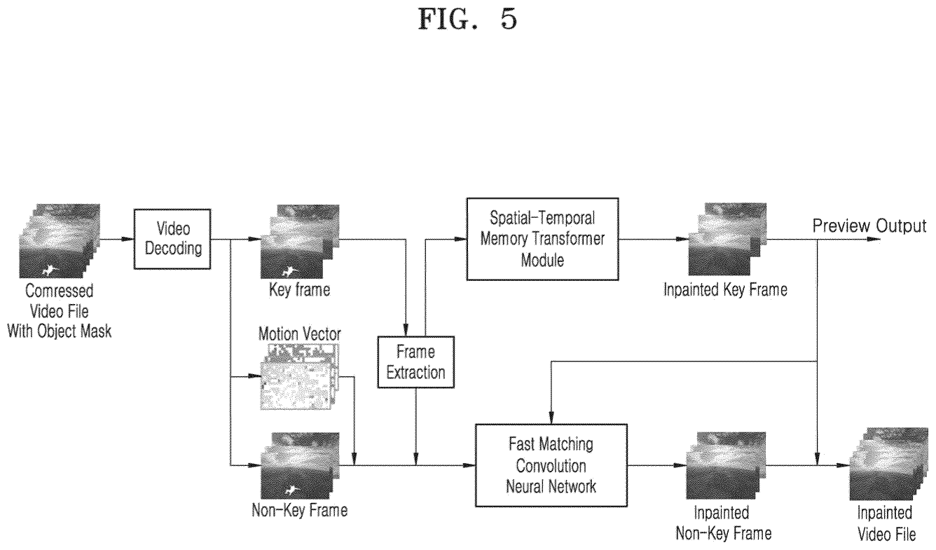

In the embodiment described above, the I-frame and/or P-frame is extracted as the key frame, and the B-frame is extracted as the non-key frame. The present disclosure proposes that, the number of the key frames may be further reduced. The extracting the at least one key frame from the video according to the decoding information of the video may include: extracting at least one frame from the video according to the decoding information of the video, determining the at least one key frame from the extracted frame based on a predetermined frame interval. For example, the at least one frame composed of the I frame and/or P frame is firstly extracted from the video based on the decoding information of the video, and then, at least one of the extracted at least one frame is extracted as the key frame based on the predetermined frame interval. Furthermore, a frame in the video other than the extracted key frame may be extracted as the non-key frame. Specifically, as shown in FIG. 5, it illustrates a process schematic diagram of a method performed by an electronic apparatus according to an embodiment of the disclosure. For example, at least one frame is extracted from a video according to decoding information, key frames are selected from the extracted at least one frame according to a predetermined frame interval, other unselected frames in the extracted at least one frame are set as the non-key frames. For example, one key frame is selected as the key frame from the extracted at least one frame at an every interval of 3 frames, and all frames in the video other than the selected key frames are set as (or extracted as) the non-key frames. In this case, the overall processing speed may be further improved since the number of the key frames is reduced. A Motion vector of the non-key frames obtained after feature extraction is unidirectional, and only a key frame needs to be quickly matched with it to guide the inpainting.

In an embodiment of the disclosure, the extracting the at least one key frame and the at least one non-key frame from the video may include: extracting a frame from the video at a predetermined frame interval to obtain the at least one key frame; and extracting at least one frame in the video other than the at least one key frame as the at least one non-key frame.

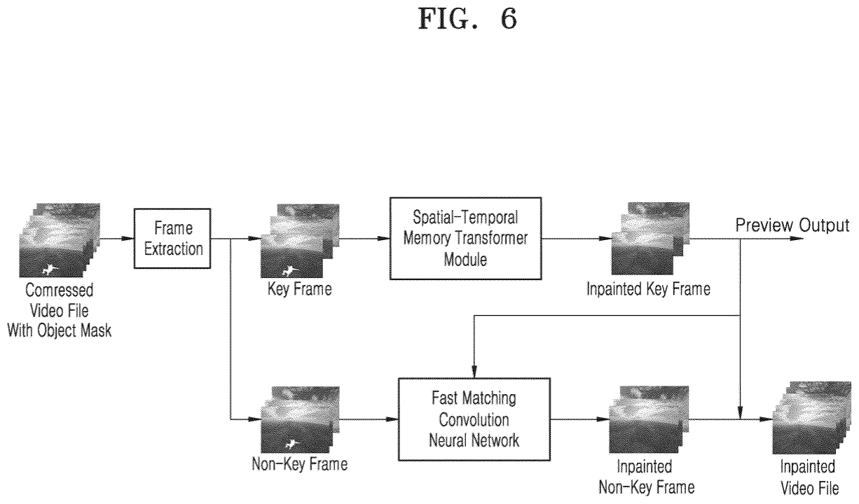

Specifically, as shown in FIG. 6, unlike the embodiments of extracting the key frame and the non-key frame from the video based on the decoding information (e.g., the motion vector) described above with reference to FIGS. 2 and 5, in this embodiment, the key frame may be extracted from the decoded video at a predetermined frame interval, and the remaining frames may be extracted as the non-key frames. For example, one frame is extracted as the key frame from the video at an every interval of 5 frames, thereby obtaining the at least one key frames, and the remaining frames are extracted as the non-key frames.

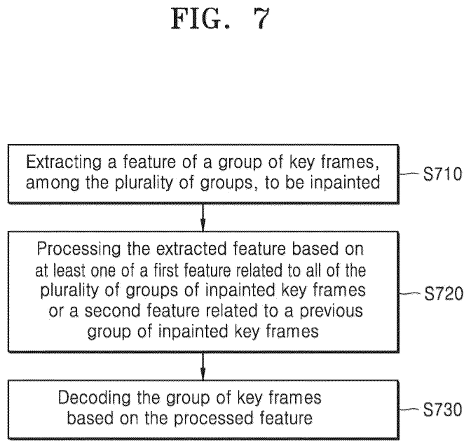

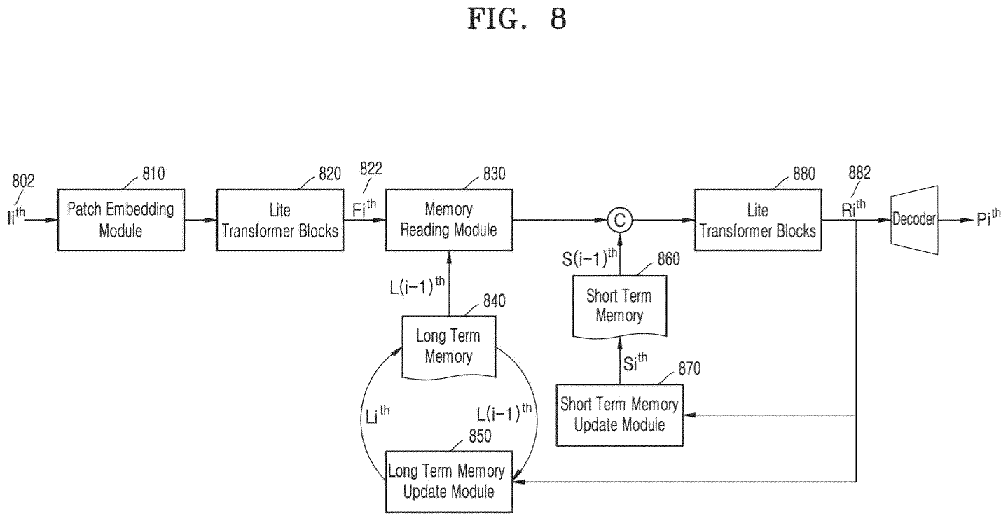

Referring back to FIG. 1, at step S120, the at least one key frame is inpainted based on at least one mask corresponding to the at least one key frame. In the embodiment of the disclosure, each group of key frames in the at least one key frame are inpainted in a common processing manner, wherein each group of key frames includes a predetermined number of key frames, wherein the predetermined number may be any positive integer greater than or equal to 1. For example, every 5 key frames consecutively arranged in the at least one key frame are considered as one group. The process of inpainting a group of key frames is described in detail below with reference to FIGS. 7 and 8. FIG. 7 is a flowchart illustrating a process of inpainting a group of key frames according to an embodiment of the disclosure. FIG. 8 is a schematic diagram illustrating a processing of a spatial-temporal memory Transformer module according to an embodiment of the disclosure.

Specifically, at step S710, a feature of a group of key frames to be inpainted is extracted. Specifically, the feature of the group of key frames to be inpainted may be obtained by performing feature encoding on the group of key frames to be inpainted. Herein, “feature” may also be referred to as “semantic feature”. As shown in FIG. 8, the i^{th} group of key frames Ii^{th} 802 are input to a patch embedding module 810 for the feature encoding, thereby obtaining a patch feature. In the following description, for the sake of easy understanding, it is assumed that the number of frames in each group of key frames is 5, but the embodiment of the disclosure is not limited thereto, and it may be any positive integer.

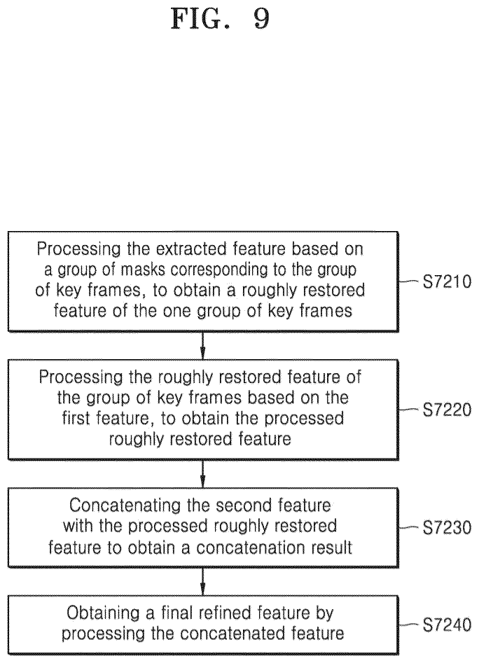

At step S720, the feature of the group of key frames are processed based on a feature of inpainted key frames, wherein the feature of the inpainted key frames may include at least one of a first feature related to all groups of inpainted key frames or a second feature related to a previous group of inpainted key frames. The process of obtaining the processed feature by processing the feature of the group of key frames is described in detail below with reference to FIGS. 8 and 9.

FIG. 9 is a flowchart illustrating a process of processing a feature of a group of key frames based on a feature of inpainted key frames according to an embodiment of the disclosure.

At step S7210, the feature of the group of key frames is processed based on a group of masks corresponding to the group of key frames, to obtain a preliminary inpainted feature of the group of key frames.

As illustrated in FIG. 8, by inputting the feature of the group of key frames obtained through the patch embedding module 810 and the group of masks corresponding to the group of key frames 802 to the Transformer module (e.g., a lite Transformer module 820), the feature of the group of key frames is processed, thereby obtaining the roughly restored feature of the group of key frames. For example, an area corresponding to the mask in each of the group of key frames are roughly restored by utilizing the lite Transformer module 820, to obtain a roughly restore features Fi^{th} 822 of the group of key frames, wherein the roughly restored feature Fi^{th} 822 may include all roughly restored features of the group of key frames.

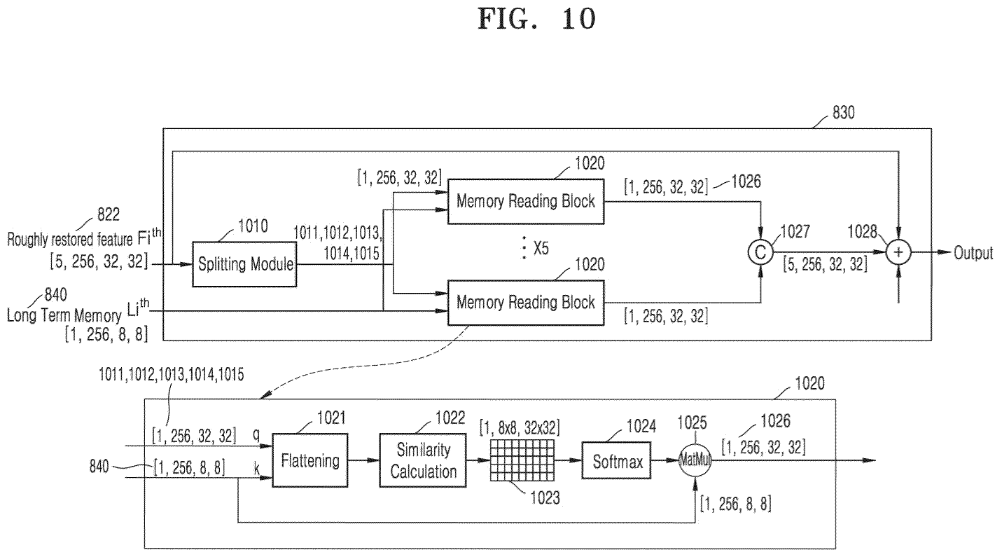

At step S7220, the roughly restored feature 822 of the group of key frames is processed based on the first feature, to obtain the processed roughly restored feature. In the embodiment of the disclosure, the “first feature” may include a feature related to all groups of key frames that have been refined, and may also be referred to as a “long term memory 840”. As shown in FIG. 8, the roughly restored feature Fi^{th} 822 of the group of key frames 802 (e.g., the roughly restored feature 822 of the group of key frames) is processed (e.g., refined) by a memory reading module 830 utilizing the long term memory 840 (e.g., the first feature), to obtain the processed roughly restored feature. The processing procedure of the memory reading module 830 (e.g., the procedure of processing the roughly restored feature of the group of key frames based on the long term memory to obtain the processed roughly restored feature) is described in detail below with reference to FIG. 10.

FIG. 10 is a process schematic diagram illustrating a processing of a memory reading module according to an embodiment of the disclosure.

Firstly, a group of fourth features may be obtained by splitting the roughly restored feature 822 of the group of key frames in a time dimension, wherein each fourth feature of the group of fourth features corresponds to one key frame in the group of key frames. As shown in FIG. 10, assuming that the rough feature Fi^{th} 822 of the group of key frames (e.g., the roughly restored feature 822 of the group of key frames) is [5,256,32,32], the rough feature Fi^{th} 822 is firstly split into one group of fourth features, e.g., 5 fourth features 1011, 1012, 1013, 1014, 1015, by a splitting module 1010 in the time dimension. Wherein this group of key frames includes a total of 5 key frames, e.g., a 1st key frame to a 5th key frame. Each fourth feature 1011, 1012, 1013, 1014, 1015 corresponds to a corresponding one of the 1st key frame to the 5th key frame. For example, a 1st fourth feature 1011 corresponds to 1st key frame, a 2nd fourth feature 1012 corresponds to the 2nd key frame, a 3rd fourth feature 1013 corresponds to the 3rd key frame, a 4th fourth feature 1014 corresponds to the 4th key frame, and a 5th fourth feature 1015 corresponds to the 5th key frame.

Then, for each fourth feature 1011, 1012, 1013, 1014, 1015 of the group of fourth features, a fifth feature 1026 with respect to an area corresponding to an object to be removed is extracted from the first feature (e.g., the long term memory 840). In the embodiment of the disclosure, the fifth feature may also be referred to as a useful feature. Furthermore, this object to be removed may be an object or target selected by a user during browsing the video, but the embodiment of the disclosure is not limited thereto.

Specifically, tokens of one fourth feature of the group of fourth features 1011, 1012, 1013, 1014, 1015 and the first feature (e.g., long term memory 840) are flattened by a memory reading block 1020, respectively; a similarity matrix 1023 is calculated by the memory reading block 1020 for the one flattened fourth feature and the flattened first feature (e.g., long term memory); a weight matrix is obtained by the memory reading block 1020 by normalizing the similarity matrix 1023; the fifth feature 1026 with respect to the area corresponding to the object to be removed is obtained by the memory reading block 1020, according to the first feature (e.g., long term memory 840) and the weight matrix. As shown in FIG. 10, assuming that tokens of each of a 1st fourth feature 1011 [1, 256, 32, 32] and a long term memory Li^{th} 840 [1, 256, 8, 8] is flattened, a one-dimensional token vector corresponding to the 1st fourth feature and a one-dimensional token vector corresponding to the long term memory Li^{th} are obtained; and then, a similarity matrix 1023 between the one-dimensional token vector corresponding to the 1st fourth feature and the one-dimensional token vector corresponding to the long term memory Li^{th} are calculated by the memory reading block 1020, for example, the similarity matrix 1023 [1, 8×8, 32×32] shown in FIG. 10 is obtained; thereafter, the similarity matrix 1023 is normalized by the memory reading block 1020 using a Softmax activation function 1024 to obtain a weight matrix; and then, the weight matrix is multiplied with the long term memory Li^{th} 840 [1, 256, 8, 8] (e.g., a matrix multiplication 1025 (MatMul) is performed) to obtain a fifth feature 1026 [1, 256, 32, 32] with respect to an area corresponding to an object to be removed.

After a fifth feature 1026 with respect to an area corresponding to an object to be removed is extracted from the first feature (e.g., the long term memory 840) for each fourth feature 1011, 1012, 1013, 1014, 1015 of the group of fourth features, the processed roughly restored feature is obtained, by concatenating 1027 the fifth features 1026 extracted for each fourth feature of the group of fourth features and adding 1028 this concatenation result to the roughly restored feature 822 of the group of key frames. As shown in FIG. 10, a concatenation result [5, 256, 32, 32] is obtained by concatenating the fifth features 1026 [1, 256, 32, 32] output by all the five memory reading blocks 1020, and then, the concatenation result [5, 256, 32, 32] is added to the roughly restored feature Fi^{th} 822 [5, 256, 32, 32] of the group of key frames, and thus the processed roughly restored feature [5, 256, 32, 32] is finally obtained.

Referring back to FIG. 9, at step S7230, the second feature is concatenated with the processed roughly restored feature. In the embodiment of the disclosure, the “second feature” is a feature related to a previous group of key frames that have been restored, and may be referred to as a “short term memory 860”. As shown in FIG. 8, the short term memory S(i−1)^{th} is concatenated with the processed roughly restored feature.

At step S7240, the processed feature (e.g., a final refined feature 882 of the group of key frames) is obtained by processing the concatenation result (e.g., the concatenated feature). As shown in FIG. 8, the concatenation result is input to a second Transformer module (e.g., a lite Transformer module 880) for processing, to obtain a final refined feature Ri^{th} 882 of the i^{th} group of key frames.

Returning to FIG. 7, at step S730, the group of key frames is decoded based on the processed feature. Specifically, the group of inpainted key frames is obtained by performing feature decoding on the final refined feature 882 of the group of key frames. As shown in FIG. 8, a group of inpainted key frames Pi^{th} is finally obtained by performing feature decoding on the final refined features Ri^{th} of the i^{th} group of key frames.

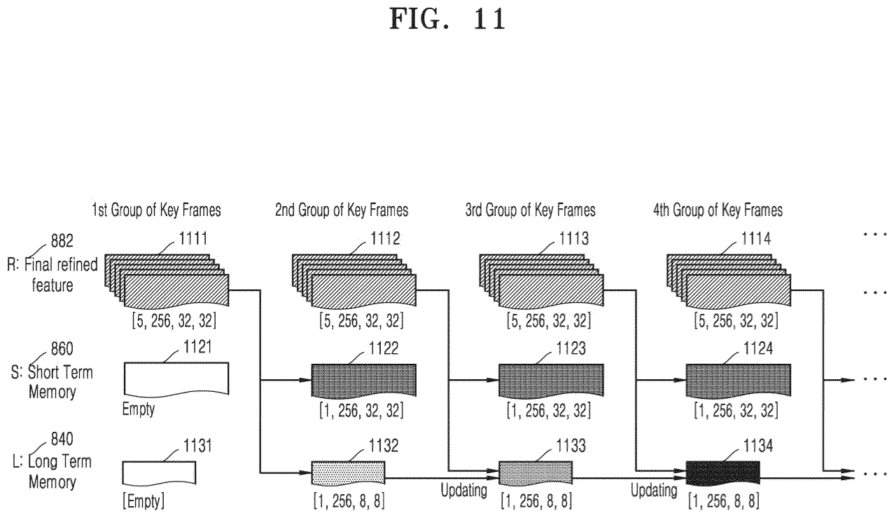

In the process described above with reference to FIGS. 7 to 10, by introducing a memory mechanism composed of the first feature (e.g., a long term memory 840) and the second feature (e.g., a short term memory 860), redundant calculations due to overlapping may be eliminated while improving a video inpainting effect. In the embodiment of the disclosure, the first feature and the second feature should be updated in a use process, e.g., updating of the spatial-temporal memory is desired. Specifically, the method illustrated in FIG. 1 may further include updating of the first feature, e.g., extracting a third feature from the processed feature based on semantic correlation; and fusing the third feature with the stored first feature and storing the fusion result as the updated first feature. Furthermore, the method may include updating of the second feature, e.g., updating the second feature based on the processed feature. The spatial-temporal memory updating process proposed in the embodiment of the disclosure is firstly described below with reference to FIG. 11.

FIG. 11 is a schematic diagram illustrating updating of a spatial-temporal memory according to an embodiment of the disclosure.

In the embodiment of the disclosure, a second feature (e.g., a short term memory 860) stores a iterative feature of a previous group of key frames while contributing to ensure a good continuity of a time sequence of the restored video. A first feature (e.g., a long term memory 840) is updated based on a final refined feature of a current group of key frames and a previously stored first feature (e.g., a previously stored long term memory), and the first feature is used to store a long term feature 840. Furthermore, due to considerations of memory usage and computational complexity, a common memory queue is not used to store these long term memory 840 and short term memory 860. Instead, the long term memory 840 is updated using a long term memory update module 850 (which may also be referred to as a first feature update module).

Specifically, as shown in FIG. 11, when restoring a first group of key frames (e.g., 5 key frames), both a short term memory 1121 and a long term memory 1131 are empty. When restoring a second group of key frames (e.g., 5 key frames), the short term memory 1122 is generated from a final refined feature 1111 of the first group of key frames, and the long term memory 1132 is generated from the final refined feature 1111 of the first group of key frames. When restoring a third group of key frames, the short term memory 1123 is generated (or updated) from the final refined feature 1112 of the second group of key frames, the long term memory 1133 is generated (or updated) from the final refined feature 1112 of the second group of key frames and the previous long term memory 1132 (e.g., a second long term memory), and so on.

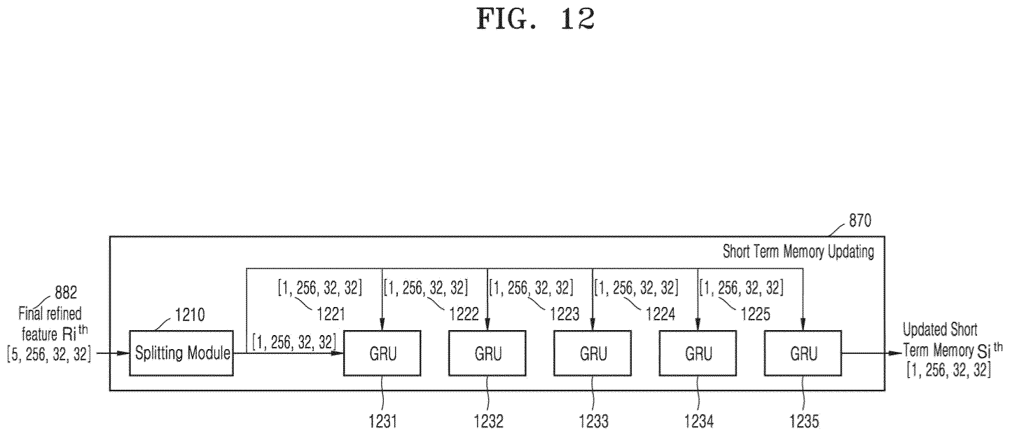

In the following, a detailed process for updating the short term memory 860 (e.g., the second feature) will be described with reference to a short term memory update module 870 (which may also be referred to as a second feature update module) illustrated in FIG. 12.

FIG. 12 is a block diagram illustrating a short term memory update module 870 according to an embodiment of the disclosure.

Firstly, a group of sixth features is obtained by splitting the processed feature (e.g., the final refined feature 882) of the group of key frames in the time dimension, wherein each sixth feature of the group of sixth features corresponds to one key frame of the group of key frames

As shown in FIG. 12, the short term memory update module 870 includes a splitting module 1210 which splitting the processed feature (e.g., the final refined feature) Ri^{th} 882 [5, 256, 32, 32] of the group of key frames into a group of sixth features in the time dimension, e.g., 5 sixth features. Specifically, the group of key frames includes a total of 5 key frames, e.g., a 1st key frame to 5th key frame, and each sixth feature corresponds to a corresponding one of the 1st key frame to the 5th key frame. For example, a 1st sixth feature 1221 corresponds to the 1st key frame, a 2nd sixth feature 1222 corresponds to the 2nd key frame, a 3rd sixth feature 1223 corresponds to the 3rd key frame, a 4th sixth feature 1224 corresponds to the 4th key frame, and a 5th sixth feature 1225 corresponds to the 5th key frame.

Then, the second feature (e.g., a short term memory 860) is updated by processing the group of sixth features 1221, 1222, 1223, 1224, 1225 using a neural network which is formed by cascading at least one Gate Recurrent Unit (GRU) module 1231, 1232, 1233, 1234, 1235, wherein an input of each GRU module includes one corresponding sixth feature in the group of sixth features, and wherein inputs of remaining GRU modules other than a first GRU module further include an output of a cascaded previous GRU module.

As shown in FIG. 12, the short term memory update module 870 may further include a plurality of cascaded GRU modules, and the number of the plurality of GRU modules is equal to the number of features included in the group of sixth features. In FIG. 12, the number of the plurality of GRU modules is 5, for example, and these 5 split sixth features 1221, 1222, 1223, 1224, 1225 are fed to the cascaded GRU modules 1231, 1232, 1233, 1234, 1235, consecutively. Specifically, 1st sixth feature 1221 [1, 256, 32, 32], which is used as a hidden state of a previous moment and input information of a current moment respectively, are fed to a 1st GRU module 1231, an output of the 1st GRU module and a 2nd sixth feature 1222 [1, 256, 32, 32], which are used as the hidden state of the previous moment and the input information of the current moment respectively, are fed to a 2nd GRU module 1232, and so on, an output of a 4th GRU module 1234 and a 5th sixth feature 1225 [1, 256, 32, 32], which are used as the hidden state of the previous moment and the input information of the current moment respectively, are fed into a 5th GRU module 1235, and finally, an output of the 5th GRU module 1235 is the updated second feature (e.g., the short term memory 860) Si^{th} [1, 256, 32, 32].

In the short term memory update module 870, the GRU module filters out important characters from the feature of one key frame and passes these characters to the next cascaded GRU module, and finally, a short term memory 860 of a group of features is generated, and this short term memory 860 may store more detailed texture features than the long term memory 840. The short term memory 860 proposed in the embodiment of the disclosure retains the most important information in adjacent frames, and since this short term memory 860 is not compressed by a spatial scale, it helps to recover more precise content in the input key frames.

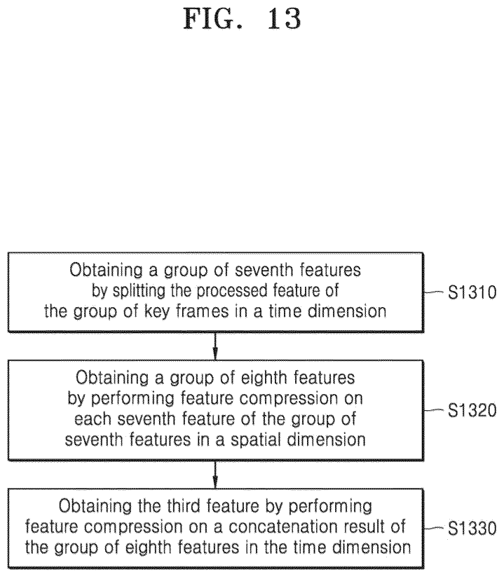

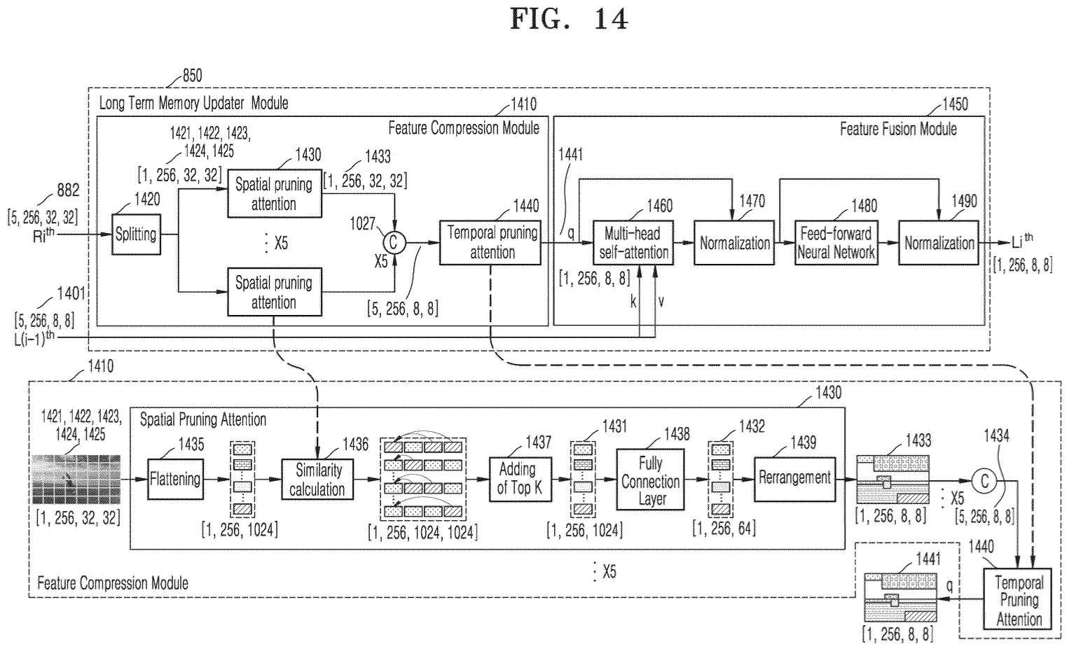

A process for updating a first feature (e.g., a long term memory 840) is described below with reference to FIGS. 13 and 14. FIG. 13 is a flowchart illustrating a process for extracting a third feature according to an embodiment of the disclosure, wherein, as described above, the third feature is fused with the previously stored first feature, and the fusion result is stored as the updated first feature. FIG. 14 is a block diagram illustrating a long term memory update module 850 according to an embodiment of the disclosure.

Firstly, at step S1310, a group of seventh features is obtained by splitting the processed feature (e.g., the final refined feature) of the group of key frames in a time dimension, wherein each seventh feature of the group of seventh features corresponds to one key frame of the group of key frames. As shown in FIG. 14, a long term memory update module 850 includes a feature compression module 1410 and a feature fusion module 1450, the feature compression module 1410 may include a splitting module 1420. Herein, a final refined features Ri^{th} [5, 256, 32, 32] of a group of key frames are split by the splitting module 1420 in the time dimension into a group of seventh features, e.g., for example, 5 seventh features 1421, 1422, 1423, 1424, 1425 in FIG. 14. Specifically, the group of key frames includes a total of 5 key frames, e.g., a 1st key frame to a 5th key frame. Each seventh feature 1421, 1422, 1423, 1424, 1425 corresponds to a corresponding one of the 1st key frame to the 5th key frame, for example, a 1st seventh feature 1421 corresponds to the 1st key frame, a 2nd seventh feature 1422 corresponds to the 2nd key frame, a 3rd seventh feature 1423 corresponds to the 3rd key frame, a 4th seventh feature 1424 corresponds to the 4th key frame, and a 5th seventh feature 1425 corresponds to the 5th key frame.

Then, at step S1320, a group of eighth features is obtained by performing feature compression on each seventh feature of the group of seventh features in a spatial dimension. Specifically, as shown in FIG. 14, the feature compression module 1410 may further include a plurality of spatial pruning attention modules 1430, wherein the number of the spatial pruning attention modules 1430 is equal to the number of the seventh features included in the group of seventh features 1421, 1422, 1423, 1424, 1425, and in FIG. 14, the number of the plurality of spatial pruning attention modules 1430 is 5, and these split 5 seventh features 1421, 1422, 1423, 1424, 1425 are fed to the 5 spatial pruning attention modules 1430, respectively, and then, one corresponding seventh feature is processed by each spatial pruning attention module 1430, to obtain one eighth feature 1433, which is described in detail below.

Specifically, as shown in FIG. 14, firstly, the spatial pruning attention module 1430 flattens tokens of the input one seventh feature [1, 256, 32, 32].

Then, a ninth feature 1431 corresponding to the one seventh feature 1421 is obtained by: for each token in the one seventh feature, the spatial pruning attention module 1430 calculates 1436 similarity matrices between each token in the one seventh feature, and fusing tokens based on the similarity matrices, for example, fusing 1437 the first k most similar tokens for each token. The k is a settable value, which may be set according to a user desire, for example, be set to 5, 10, 15, and the like. Specifically, as shown in FIG. 14, there are a total of 1024 tokens in the seventh feature [1, 256, 32, 32], and assuming that a current token is a first flattened token, similarity matrices between each token in this seventh feature (including the current token and remaining tokens in this seventh feature) should be calculated, to determine the first k tokens that are most similar to the current token. Thereafter, by fusing 1437 the first k tokens most similar to the current token (e.g., fusing the current token with the first k-1 tokens most similar to it) to obtain a fused current token, and by following similar processes, the fused token for each token in this one seventh feature may be obtained, and thus the ninth feature corresponding to that one seventh feature may be obtained, e.g., a ninth feature 1431 [1, 256, 1024] in FIG. 14.

Thereafter, a tenth feature corresponding to the one seventh feature is obtained by performing fully connection 1438 on tokens of the ninth feature. Specifically, as shown in FIG. 14, the number of tokens may be reduced by performing fully connection 1438 on the 1024 tokens of the ninth feature 1431 [1, 256, 1024], to reduce the number of tokens, and thus a tenth feature 1432 [1, 256, 64] is obtained. However, this is only an example, and the number of tokens in the tenth feature is not limited thereto, but may also be other values.

Then, the one eighth feature is obtained by rearranging the tenth feature, e.g., the feature on which a feature compression has been performed in the spatial dimension. As shown in FIG. 14, after rearranging 1439 the tenth feature 1432 [1, 256, 64], an eighth feature 1433 [1, 256, 8, 8] is obtained.

Referring back to FIG. 13, at step S1330, the third feature is obtained by performing feature compression on a concatenation result of the group of eighth features in the time dimension. Specifically, as shown in FIG. 14, the feature compression module 1410 may further include a temporal pruning attention module 1440, which in the embodiment of the disclosure has the same structure as that of the spatial pruning attention module 1430 illustrated in FIG. 14.

Specifically, firstly, tokens of the concatenation result 1434 [5, 256, 8, 8] of the group of eighth feature is flattened. The concatenation result 1434 [5, 256, 8, 8] is obtained by concatenating outputs 1433 of the 5 spatial pruning attention modules 1430, and, herein, the concatenation result 1434 [5, 256, 8, 8] may be regarded as one feature. Therefore, after performing a flattening on it according to the tokens, one feature [1, 256, 320] is obtained, wherein 320=8×8×5.

Thereafter, an eleventh feature corresponding to the concatenation result of the group of eighth features is obtained by: for each token in the concatenation result of the group of eighth features, calculating similarity matrices between each token in the concatenation result of the group of eighth features, and fusing tokens based on the similarity matrices, for example, for each token, fusing the first m most similar tokens thereof. Wherein, similar to k, m is a settable value.

Then, a twelfth feature corresponding to the concatenation result of the group of eighth features is obtained by performing fully connection on tokens of the eleventh feature. Specifically, a twelfth feature [1, 256, 64] may be obtained by performing fully connection on 320 tokens of an eleventh feature [1, 256, 320] to reduce the number of tokens. However, this is only an example, and the number of tokens in the twelfth feature is not limited thereto, but may also be other values.

Thereafter, the third feature 1441 is obtained by rearranging the twelfth feature. For example, the feature on which a feature compression has been performed in the time dimension (e.g., compressed feature) is obtained, thus a temporal attention enhanced result. Specifically, after rearranging the twelfth feature [1, 256, 64], the third feature 1441 [1, 256, 8, 8] is obtained.

After the third feature is extracted through the process of FIG. 13 as described above, the third feature is fused with the stored first feature, and the fusion result is stored as the updated first feature.

Specifically, as shown in FIG. 14, the feature fusion module 1450 includes a multi-head attention module 1460, a first normalization module 1470, a feedforward neural network 1480, and a second normalization module 1490. The current compressed feature 1441 [1, 256, 8, 8] which is used as an input q and the previously stored first feature (e.g., a long term memory 840) L(i−1)^{th} [1, 256, 8, 8] which are used as inputs k and v are input into the multi-head attention module 1460 for processing. Then, the first normalization module 1470 is utilized to perform normalization processing on the processing result of the multi-head attention module 1460 and the current compressed feature 1441 [1, 256, 8, 8]. Thereafter, the feedforward neural network 1480 is utilized to feed the normalization result to the second normalization module 1490 for normalization processing. Finally, the updated first feature may be obtained. The updated first feature may combine feature information of the current moment with these of all the previous moments, for example, the first feature may store effective features for a longer period of time, and the feature fusion module 1450 may compress these features at both temporal and spatial scales.

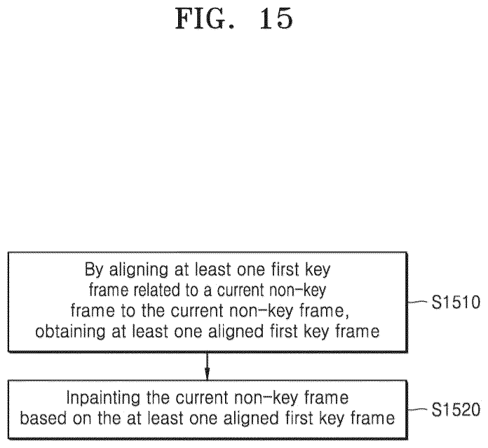

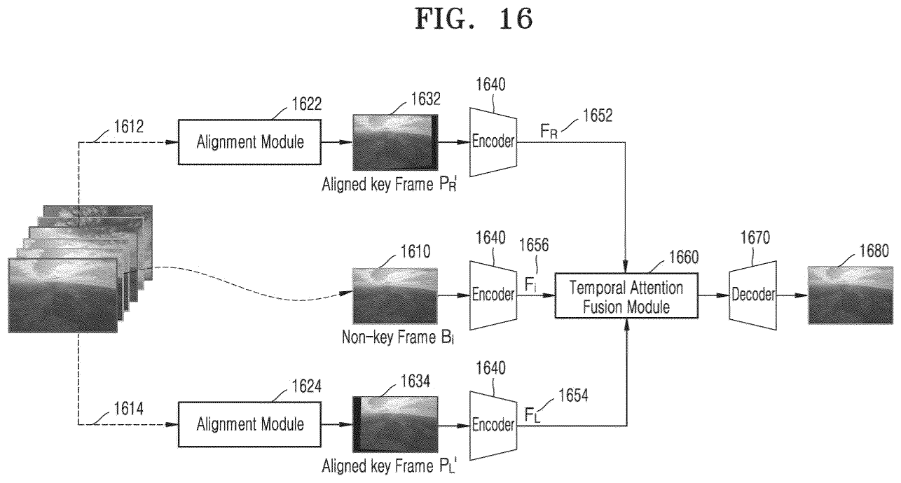

Referring back to FIG. 1, at step S130, the at least one non-key frame is inpainted based on the at least one inpainted key frame. Herein, each of the at least one non-key frame is inpainted by a similar process, which will be described in detail below with reference to FIGS. 15 and 16.

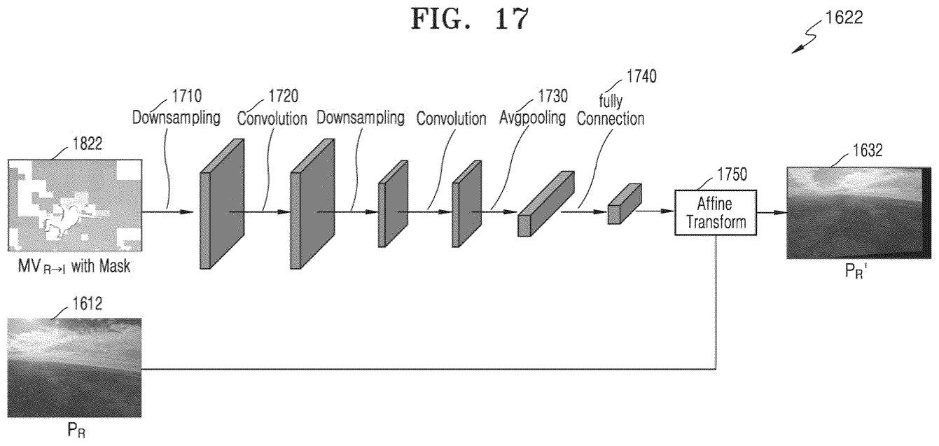

FIG. 15 is a flowchart illustrating a process of inpainting a non-key frame according to an embodiment of the disclosure. FIG. 16 is a schematic diagram illustrating a process of inpainting a non-key frame according to an embodiment of the disclosure, wherein this inpainting process is implemented by a fast matching convolution neural network proposed in the embodiment of the disclosure, wherein the fast matching convolution neural network includes two alignment modules 1622, 1624, a plurality of encoders 1640, a temporal attention fusion module 1660, and a decoder 1670. FIG. 17 is a schematic diagram illustrating a structure of an alignment module according to an embodiment of the disclosure.

At step S1510, by aligning at least one first key frame related to a current non-key frame to the current non-key frame, at least one aligned first key frame is obtained. Specifically, the obtaining the at least one aligned first key frame may include: performing the following operations for each first key frame, to obtain one aligned first key frame: obtaining the one aligned first key frame, based on motion vector information of the current non-key frame relative to the one first key frame. Herein, the term “first key frame” is used to denote a key frame related to the current non-key frame among the extracted at least one key frame.

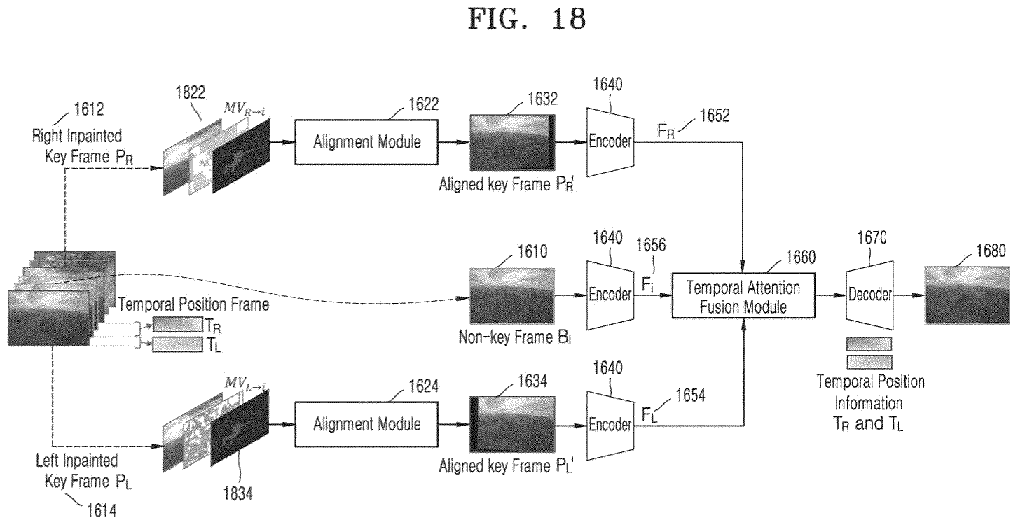

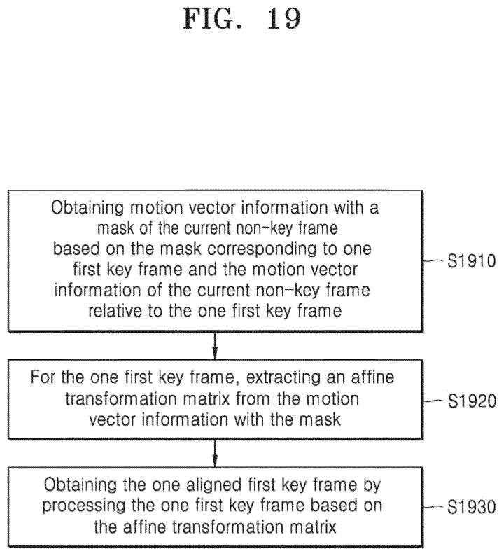

In an embodiment of the disclosure, the alignment module may be the alignment module 1622 illustrated in FIG. 17, in this case, FIG. 16 is refined as that shown in FIG. 18. Specifically, the alignment module illustrated in FIG. 17 is an alignment regression network based on motion vector information, which therefore requires that the non-key frame has motion vector information relative to the key frame. The process of obtaining the one aligned first key frame based on the motion vector information of the current non-key frame relative to the one first key frame is described in detail below with reference to FIGS. 17 and 19.

FIG. 19 is a flowchart illustrating a process of obtaining one aligned first key frame based on motion vector information of a current non-key frame relative to one first key frame according to an embodiment of the disclosure.

At step S1910, motion vector information with a mask of the current non-key frame (e.g., motion vector information with a mask of the current non-key frame relative to the one first key frame) is obtained based on the mask corresponding to one first key frame and the motion vector information of the current non-key frame relative to the one first key frame. Wherein, as described above, the motion vector information of the current non-key frame relative to the one first key frame is obtained from the decoding information of the video.

As shown in FIG. 18, a current non-key frame Bᵢ 1610 has two key frames closest thereto in different time directions, e.g., a left inpainted key frame P_{L} 1614 closest to the left of the current non-key frame Bᵢ 1610 and a right inpainted key frame P_{R} 1612 closest to the right of the current non-key frame Bᵢ 1610. In the embodiment of the disclosure, the left inpainted key frame P_{L} 1614 and the right inpainted key frame P_{R} 1612 may be referred to as first key frames, or they may be referred to as adjacent key frames.

As shown in an upper signal flow in FIG. 18, the right inpainted key frame P_{R} 1612, motion vector information MV_{R→i} 1822 of the current non-key frame Bᵢ relative to the right inpainted key frame P_{R}, and a mask corresponding to the right inpainted key frame P_{R} are inputted into an upper alignment regression module 1622, in which the motion vector information MV_{R→i} 1822 represents a motion vector from the right inpainted key frame P_{R} 1612 to the current non-key frame Bᵢ 1610, the motion vector may define a displacement of pixels between two frames. Herein, the motion vector information MV_{R→i} 1822 may define a displacement of pixels between the right inpainted key frame P_{R} 1612 and the current non-key frame Bᵢ 1610, and similarly, motion vector information MV_{L→i} 1834 may represent a motion vector from the left inpainted key frame P_{L} 1614 to the current non-key frame Bᵢ 1610.

As shown in FIG. 17, the alignment regression module 1622 performs a mask operation on the motion vector information MV_{R→i} 1822 of the current non-key frame Bᵢ 1610 relative to the right inpainted key frame P_{R} 1612 based on the mask corresponding to the right inpainted key frame P_{R} 1612, to obtains motion vector information MV_{R→i} 1822 with the mask of the current non-key frame Bᵢ 1810 relative to the right inpainted key frame P_{R} 1612, wherein, this mask is a mask of the object and characterizes an object region, and since the motion vector of the area of the object is often inaccurate, this mask operation process may eliminate an influence of a foreground area (e.g., the object area) and retains only the motion vector information of a background area.

At step S1920, for the one first key frame, an affine transformation matrix is extracted from the motion vector information with the mask.

Specifically, as shown in FIG. 17, for the right inpainted key frame P_{R} 1612, the alignment module 1622 may extract an affine transformation matrix from the motion vector information MV_{R→i} 1822 with the mask of the current non-key frame Bᵢ 1610 relative to the right inpainted key frame P_{R} 1612. Specifically, since a motion change between frames are slight, a lite model may be used to extract the affine transformation matrix from the motion vector information 1822. As shown in FIG. 17, a series of downsampling 1710, convolution 1720, average pooling 1730 (avgpooling), and full concatenation 1740 operations may be performed by the lite model on the motion vector information MV_{R→i} 1822 with the mask, to obtain the affine transformation matrix 1750 to be applied to the right inpainted key frame P_{R} 1612.

S1930, the one aligned first key frame is obtained by processing the one first key frame based on the affine transformation matrix 1750.

As shown in FIG. 17, the alignment module 1622 obtains the right inpainted key frame P_{R}′ 1632 aligned with the current non-key frame Bᵢ 1610, by processing (e.g., multiplying) the right inpainted key frame P_{R} based on the extracted affine transformation matrix 1750.

Similarly, as shown in FIG. 18, the left inpainted key frame P_{L} 1614, the motion vector information MV_{L→i} 1834 of the current non-key frame Bᵢ 1610 relative to the left inpainted key frame P_{L} 1614, and a mask corresponding to the left inpainted key frame P_{L} 1614 may be input to a lower alignment module 1624, wherein the motion vector information 1834 MV_{L→i} may represent a motion vector from the left inpainted key frame P_{L} 1614 to the current non-key frame Bᵢ 1610. Similar to the process of obtaining the right inpainted key frame P_{R}′ 1632 aligned with the current non-key frame Bᵢ 1610, the lower alignment module 1624 may obtain the left inpainted key frame P_{L}′ 1634 aligned with the current non-key frame Bᵢ 1610 in a similar process.

In an embodiment of the disclosure, instead of using the alignment module 1622 illustrated in FIG. 17, the alignment module may use a conventional alignment method or a pixel-based depth alignment model to align the left inpainted key frame P_{L} 1614 and the right inpainted key frame P_{R} 1612 to the current non-key frame Bᵢ 1610, thereby obtaining the left inpainted key frame P_{L}′ 1634 aligned with the current non-key frame Bᵢ 1610 and the right inpainted key frame P_{R}′ 1632 aligned with the current non-key frame Bᵢ 1610. Any method that may align one frame to another may be applied in the embodiment of the disclosure, which is not described in detail herein, and any method that may align one frame to another may be applied to the alignment module of the embodiment of the disclosure.

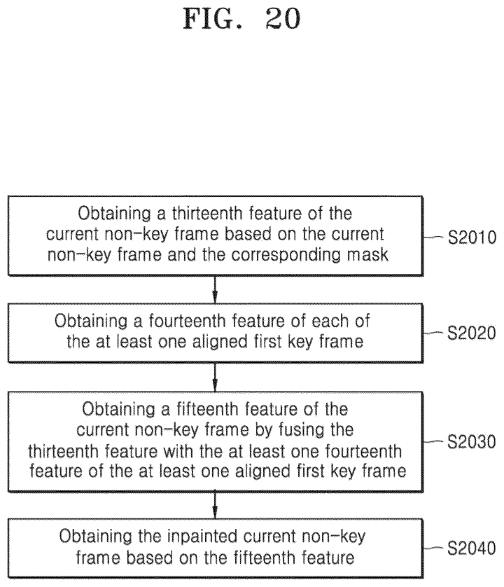

Referring back to FIG. 15, at step S1520, the current non-key frame is inpainted based on the at least one aligned first key frame. This is described below with reference to FIG. 16 and FIG. 20.

FIG. 20 is a flowchart illustrating a process of inpainting a current non-key frame based on at least one aligned first key frame according to an embodiment of the disclosure.

At step S2010, a thirteenth feature of the current non-key frame is obtained based on the current non-key frame and a corresponding mask.

Specifically, this step S2010 may include: obtaining the fused current non-key frame by performing fusing processing on the current non-key frame through a mask corresponding to the current non-key frame, and obtaining the thirteenth feature of the current non-key frame by performing feature coding on the fused current non-key frame. As shown in FIG. 16 or 18, before the feature encoding of the current non-key frame Bᵢ 1610 through an encoder 1640, it should use the mask of the current non-key frame Bᵢ 1610 to perform a mask operation (e.g., perform the fusion processing) on the current non-key frame Bᵢ 1610, to remove the area of the object to be removed, thereby obtaining the fused current non-key frame. Thereafter, the feature Fᵢ 1656 (e.g., the thirteenth feature) of the current non-key frame Bᵢ 1610 is extracted by encoding the fused current non-key frame Bᵢ with a shared lite encoder 1640.

At step S2020, a fourteenth feature of each of the at least one aligned first key frame is obtained.

Specifically, as shown in FIG. 16, a feature F_{L} 1654 of the aligned left inpainted key frame P_{L}′ 1634 and a feature F_{R} 1652 of the aligned right inpainted key frame P_{R}′ 1632 may be extracted by encoding the left inpainted key frame P_{L}′ 1634 aligned with the current non-key frame Bᵢ and the right inpainted key frame P_{R}′ 1632 aligned with the current non-key frame Bᵢ, respectively, with a lite encoder 1640 shared with the current non-key frame. For example, the aligned fourteenth feature 1652, 1654 of each of these two key frames is obtained.

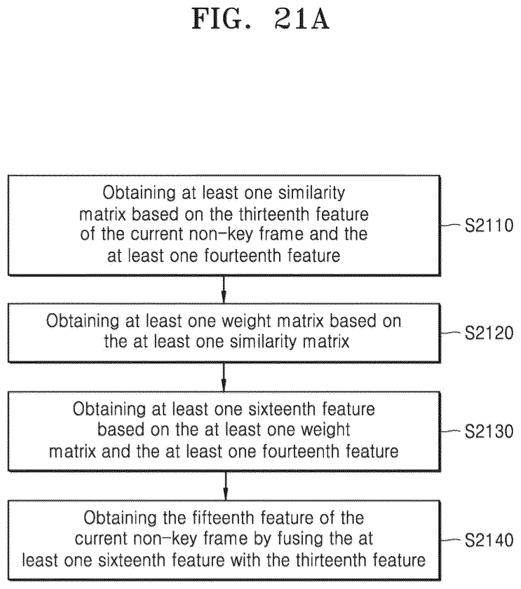

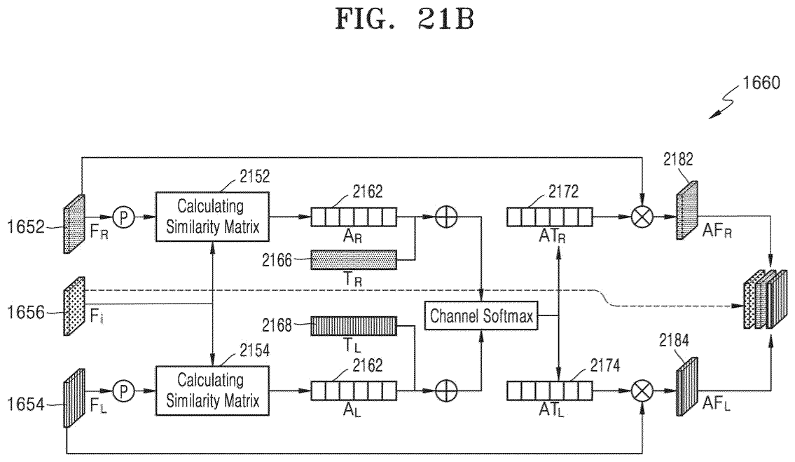

At step S2030, a fifteenth feature of the current non-key frame is obtained by fusing the thirteenth feature and the at least one fourteenth feature of the at least one aligned first key frame. This is described in detail below with reference to FIG. 21A.

FIG. 21A is a flowchart illustrating a process of fusing a thirteenth feature and at least one fourteenth feature of at least one aligned first key frame to obtain a fifteenth feature of a current non-key frame according to an embodiment of the disclosure.

At step S2110, at least one similarity matrix is obtained based on the thirteenth feature of the current non-key frame and the at least one fourteenth feature.

As shown in FIG. 21B, assuming that the current non-key frame Bᵢ 1610 has two key frames closest thereto in time, e.g., a left inpainted key frame P_{L} 1614 closest to the left of the current non-key frame Bᵢ, and a right inpainted key frame P_{R} 1612 closest to the right of the current non-key frame Bᵢ, and accordingly, through the process described above with reference to FIG. 16, a thirteenth feature Fᵢ 1656 of the fused current non-key frame Bᵢ, a fourteenth feature F_{L} 1654 of the aligned left inpainted key frame P_{L}′, and a fourteenth feature F_{R} 1652 of the aligned right inpainted key frame P_{R}′ may be obtained, which may be input to a temporal attention fusion module 1660.

Firstly, a similarity matrix M_{L} 2154 between the thirteenth feature Fᵢ 1656 of the fused current non-key frame and the fourteenth feature F_{L} 1654 of the aligned left inpainted key frame P_{L}′, and a similarity matrix M_{R} 2152 between the thirteenth feature Fᵢ 1656 of the fused current non-key frame and the fourteenth feature F_{R} 1652 of the aligned right inpainted key frame P_{R}′, are calculated, respectively.

At step S2120, at least one weight matrix is obtained based on the at least one similarity matrix.

Specifically, based on these two obtained similarity matrices M_{L} and M_{R}, weight matrices AT_{R} and AT_{L} corresponding to the similarity matrices M_{L} and M_{R} are obtained, respectively. Specifically, the obtaining the at least one weight matrix based on the at least one similarity matrix may include: obtaining at least one pooled similarity matrix by performing channel dimension avgpooling on each of the at least one similarity matrix; processing the at least one pooled similarity matrix based on temporal position information related to the at least one aligned key frame; normalizing the at least one processed pooled similarity matrix, to obtain at least one weight matrix.

As shown in FIG. 21B, firstly, by performing channel dimension avgpooling on the two obtained similarity matrices M_{L} and M_{R}, respectively, a pooled similarity matrix A_{L} 2164 corresponding to the similarity matrix M_{L} and a pooled similarity matrix A_{R} 2162 corresponding to the similarity matrix M_{R} are obtained. Wherein feature sizes of A_{L} and A_{R} both are 1×1×C, wherein C represents the number of channels, and specifically, herein, C represents a dimension of A_{L} and A_{R}, respectively.

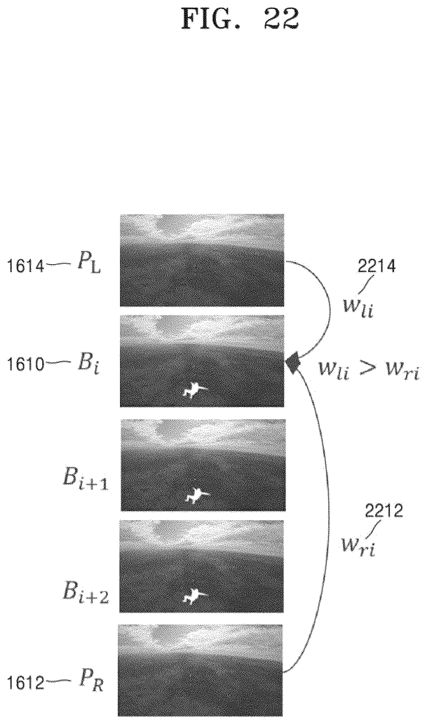

Then, the pooled similarity matrix A_{L} 2164 is processed (e.g., augmented) based on temporal position information T_{L} 2168 corresponding to the aligned left inpainted key frame P_{L}′ and the pooled similarity matrix A_{R} 2162 is processed (e.g., augmented) based on temporal position information T_{R} 2166 corresponding to the aligned right inpainted key frame P_{R}′, thereby obtaining the processed pooled similarity matrices A_{L}′ and A_{R}′. Specifically, temporal location information T_{L} may be added to each element of the pooled similarity matrix A_{L} to cause the pooled similarity matrix A_{L} to obtain a temporal representation, thereby characterizing continuity of the video inpainting in time. Similarly, the temporal location information T_{R} may be added to each element of the pooled similarity matrix A_{R} to cause the pooled similarity matrix A_{R} to obtain a temporal representation. As shown in FIG. 22, the right inpainted key frame P_{R} 1612 and the left inpainted key frame P_{L} 1614 are two adjacent key frames, both of which are used as reference frames for the current non-key frame Bᵢ 1610. Since P_{L} 1614 is closer in time to Bᵢ 1610 than P_{R} 1612, the left inpainted key frame P_{L} 1614 has a greater influence on the non-key frame Bᵢ 1610, and therefore a corresponding weight wₗᵢ 2214 in the weight matrix thereof should be greater than a corresponding weight wᵣᵢ 2212 in the weight matrix of the right inpainted key frame P_{R}. The time position information may be used to learn this timing representation, in other words, the time position information may be used for a temporal relationship between a key frame and a non-key frame. Therefore, initial values of the time position information T_{L} 2168 and T_{R} 2166 may be determined by the number of non-key frames between the left inpainted key frame P_{L} and the right inpainted key frame P_{R} as well as a time position of the current non-key frame. For example, assuming that the number of these non-key frames is 10, and the current non-key frame Bᵢ is the 2nd non-key frame located to the right of the left inpainted key frame P_{L} (e.g., the temporal position of the current non-key frame is 2), then T_{L} may be 2/10=0.2, and T_{R} is 1−0.2=0.8, but this is only an example, and the embodiment of the disclosure is not limited thereto.

Thereafter, the processed pooled similarity matrices A_{L}′ and A_{R}′ are normalized in the channel dimension by using a Softmax activation function, to obtain the normalized weight matrices AT_{R} 2172 and AT_{L} 2174. Specifically, two elements in each corresponding position in A_{L}′ and A_{R}′ are normalized, respectively. For example, assuming that elements in a first position in A_{L}′ and A_{R}′ are 0.3 and 0.9, respectively, by normalizing these two values, 0.3/(0.3+0.9)=0.25 and 0.9/(0.3+0.9)=0.75 may be obtained as the normalized elements (e.g., weights) on the first position in A_{L}′ and A_{R}′.

At step S2130, at least one sixteenth feature is obtained based on the at least one weight matrix and the at least one fourteenth feature. Specifically, the at least one sixteenth feature is obtained by weighting a corresponding one of the at least one fourteenth feature based on each of the at least one weight matrix. As shown in FIG. 21B, a right sixteenth feature AF_{R} 2182 is obtained by weighting the fourteenth feature F_{R} 1652 of the aligned right inpainted key frame P_{R}′ based on the normalized weight matrix AT_{R} 2172. Similarly, a left sixteenth feature AF_{L} 2184 is obtained by weighting the fourteenth feature F_{L} 1654 of the aligned left inpainted key frame P_{L}′ based on the normalized weight matrix AT_{L} 2174.

At step S2140, the fifteenth feature of the current non-key frame is obtained by fusing the at least one sixteenth feature and the thirteenth feature.

As shown in FIG. 21B, by fusing the thirteenth feature Fᵢ 1656 of the fused current non-key frame Bᵢ and the right sixteenth feature AF_{R} 2182 and the left sixteenth feature AF_{L} 2184, the fifteenth feature (e.g., a time-position enhanced feature map) of the current non-key frame Bᵢ is obtained.

In the embodiment of the disclosure, the time attention fusion module, by utilizing the time position information in the above process, adjusts importance of a key frame to a non-key frame, enhances perception of the time dimension, ensures continuity of the time dimension, ensures time consistency of the video inpainting, and solves a problem of frame discontinuity that occurs when the non-key frames are inpainted.

Referring back to FIG. 20, at step S2040, the inpainted current non-key frame is obtained based on the fifteenth feature. Specifically, the inpainted current non-key frame is obtained by performing feature decoding on the fifteenth feature of the current non-key frame. As shown in FIG. 16, the inpainted current non-key frame is obtained by performing the feature decoding the fifteenth feature of the current non-key frame using a decoder.

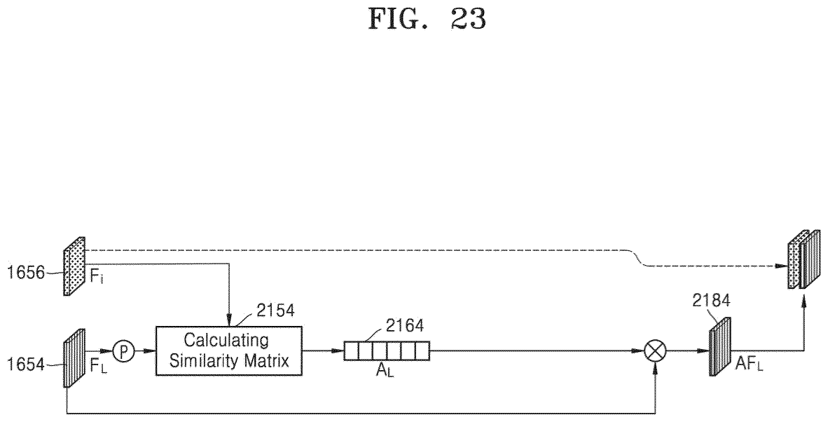

In the above description of examples with reference to the accompanying drawings (e.g., FIGS. 16 to 22), it is assumed that there are two key frames (e.g., the right inpainted key frame P_{R} 1612 and the left inpainted key frame P_{L} 1614) in the current non-key frame Bi 1610, but the embodiment of the disclosure is not limited thereto. For example, in the example illustrated in FIG. 5, during the process of extracting the at least one key frame and the at least one non-key frame from the video, it may be possible to set at least one key frame of the key frames extracted according to the decoding information, as the non-key frame, for example, a portion of the P frames is set as the non-key frame, and unlike the B frames which are non-key frames, motion vectors of the P frames are unidirectional, and thus, when inpainting of the non-key frames of the P frame type, only one of the alignment modules will operate in FIG. 16, while the other alignment module will not operate. Similarly, when inpainting of the non-key frames of the P-frame type, only one alignment module will operate in FIG. 18, and no temporal position information will be used for augmentation processing in the temporal attention fusion module, e.g., a simplified temporal attention fusion module such as that illustrated in FIG. 23 should be obtained by simplifying the structure of FIG. 21B. In FIG. 23, only the similarity matrix between, for example, the fourteenth feature F_{L} 1654 of the aligned left inpainted key frame P_{L}′ and the thirteenth feature Fᵢ 1656 of the fused current non-key frame is computed, and then, the pooled similarity matrix A_{L} 2164 is obtained by performing the channel dimension avgpooling on this similarity matrix, thereafter, the left sixteenth feature AF_{L} 2184 is obtained by directly multiplying this pooled similarity matrix A_{L} 2164 with the fourteenth feature F_{L} 1654, and finally, the thirteenth feature Fᵢ 1656 of the fused current non-key frame and the left sixteenth feature AF_{L} 2184 are fused. In the method described above with reference to FIG. 1 performed by the electronic apparatus, after inpainting the at least one key frame through step S120, step S130 is performed, e.g., inpainting the at least one non-key frame based on the at least one inpainted key frame, but the embodiment of the disclosure is not limited thereto. The described method may further include: after inpainting the at least one key frame through step S120, displaying a video containing the at least one inpainted key frame, and receiving a continue inpainting instruction or a re-inpainting instruction input by a user. For example, the video composed of the at least one inpainted key frame is displayed, the user previews the video and confirms whether the inpainting result of the key frames satisfies a requirement. If it satisfies the requirement, the user inputs the continue inpainting instruction, and thereafter, according to the continue inpainting instruction, the method inpaints at least one non-key frame based on the at least one inpainted key frame and displays a video containing the at least one inpainted key frame and the at least one inpainted non-key frame. If it does not satisfy the requirement, the user inputs the re-inpainting instruction, and thereafter, according to the re-inpaint instruction, the method may re-perform step S110, for example, re-extract a at least one key frame and a at least one non-key frame, at this time, the at least one key frame and the at least one non-key frame may be extracted in the same manner as the previous one or in a different manner from the previous one; and then the subsequent steps S120 and the like are sequentially performed.

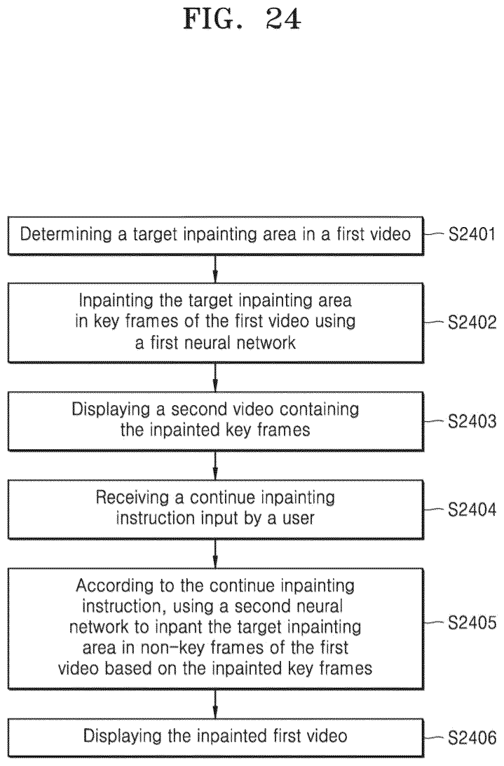

FIG. 24 is a flowchart illustrating a method performed by an electronic apparatus according to an embodiment of the disclosure.

At step S2401, a target inpainting area in a first video is determined. Specifically, the first video may be a video to be processed, and the target inpainting area may be determined in the first video based on a user selection, e.g., the user may select the target inpainting area in the displayed first video.

The method may further include: after determining the target inpainting area, deleting, from the first video, a frame that does not includes the target inpainting area. By this process, the number of frames to be processed may be reduced and the operation efficiency may be improved.

At step S2402, the target inpainting area in key frames of the first video is inpainted using a first neural network. Specifically, the key frames may be determined using the extraction method as described above with reference to step S110 of FIG. 1, and the spatial-temporal memory Transformer module as described above with reference to FIG. 8 may be used to perform the process of inpainting the target inpainting area in the key frames, which will not be repeated herein since they have been described in detail above.

At step S2403, a second video containing the inpainted key frames is displayed. Herein, the displayed second video may be a video containing only the inpainted key frames, so that the user may easily recognize whether the inpainting result of these key frames is satisfied.

At step S2404, a continue inpainting instruction input by the user is received. Specifically, the user may input the continue inpainting instruction after viewing the second video containing the inpainted key frames, e.g., if the user is satisfied with the inpainting result of the key frames, the continue inpainting instruction may be input.

At step S2405, according to the continue inpainting instruction, a second neural network is used to inpaint the target inpainting area in non-key frames of the first video based on the inpainted key frames. Specifically, the process described above with reference to FIG. 15 may be used to inpaint the target inpainting area in the non-key frames, and as described above, this inpainting process may be implemented by the fast matching convolution neural network proposed in the embodiment of the disclosure, which will not be repeated herein since these have been described in detail above.

The method may further include: receiving a re-inpainting instruction input by the user, after displaying the second video; re-determining a target inpainting area in the first video according to the re-inpainting instruction; and inpainting the re-determined target inpainting area in the key frames of the first video using the first neural network.

Specifically, as described above at step S2404, the user may browse the second video containing the inpainted key frames and input the continue inpainting instruction, but the user may also input the re-inpainting instruction. For example, if the user is dissatisfied with the inpainting result of the key frames, the re-inpainting instruction may be input. In this case, the target inpainting area in the first video may be re-determined according to the re-inpainting instruction, for example, the target inpainting area is re-determined in the first video based on the user selection, and the re-determined target inpainting area in the key frames of the first video is inpainted using the first neural network, thereafter, a video containing the inpainted key frames this time may be displayed and the user may browse this video to determine whether the inpainting result is satisfactory, and if so, the subsequent processing is performed, and if not, this process may be repeated until the user is satisfied.

In addition, the method may further include: receiving a setting instruction for setting other target inpainting areas input by the user, after displaying the second video; determining the other target inpainting areas in the inpainted key frames according to the setting instruction; inpainting the other target inpainting areas in the inpainted key frames using the first neural network.

Specifically, as described above at step S2404, the user may browse the second video containing the inpainted key frames and input the continue inpainting instruction, but the user may also input a setting instruction for setting other target inpainting areas. For example, although the user is satisfied with the current inpainting result of the key frames, the user wants to further inpaint the other target areas, at this time, the user may input the setting instruction for setting the other target inpainting areas. In this case, the other target inpainting areas may be further determined in the inpainted key frames according to the setting instruction, e.g., the other target inpainting areas are further determined in the inpainted key frame according to the user selection, and the other target inpainting areas in the inpainted key frame are inpainted using the first neural network, thereafter, a video containing the current inpainted key frames may be displayed and the user may browse the video to determine whether the inpainting result is satisfactory, and if so, the subsequent processing is performed, and if not, this process may be repeated until the user is satisfied.

At step S2406, the inpainted first video is displayed. Specifically, the inpainted first video may be a video containing the inpainted key frames and the inpainted non-key frames.

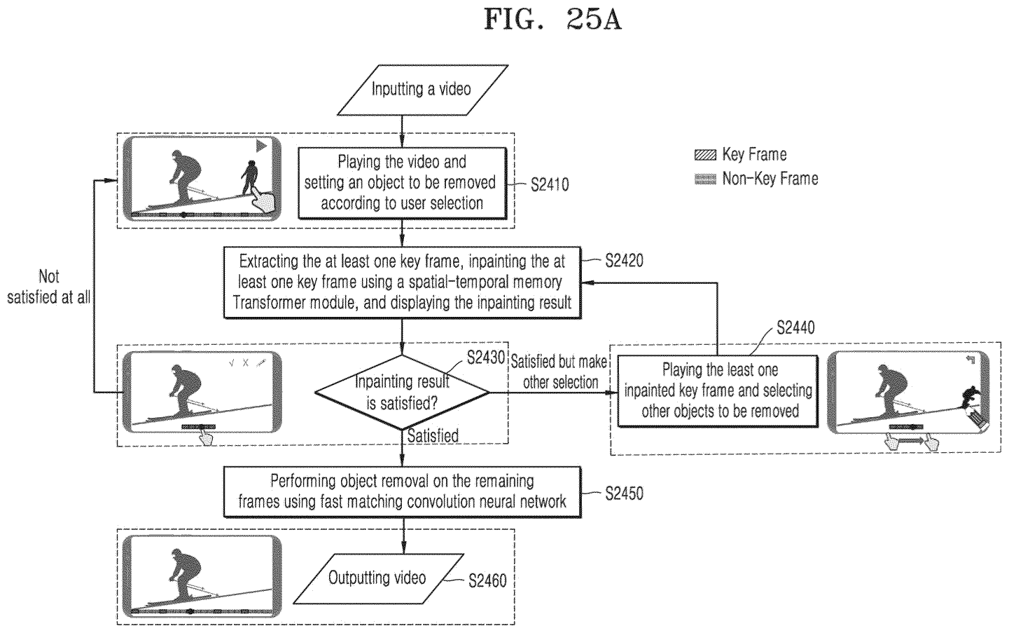

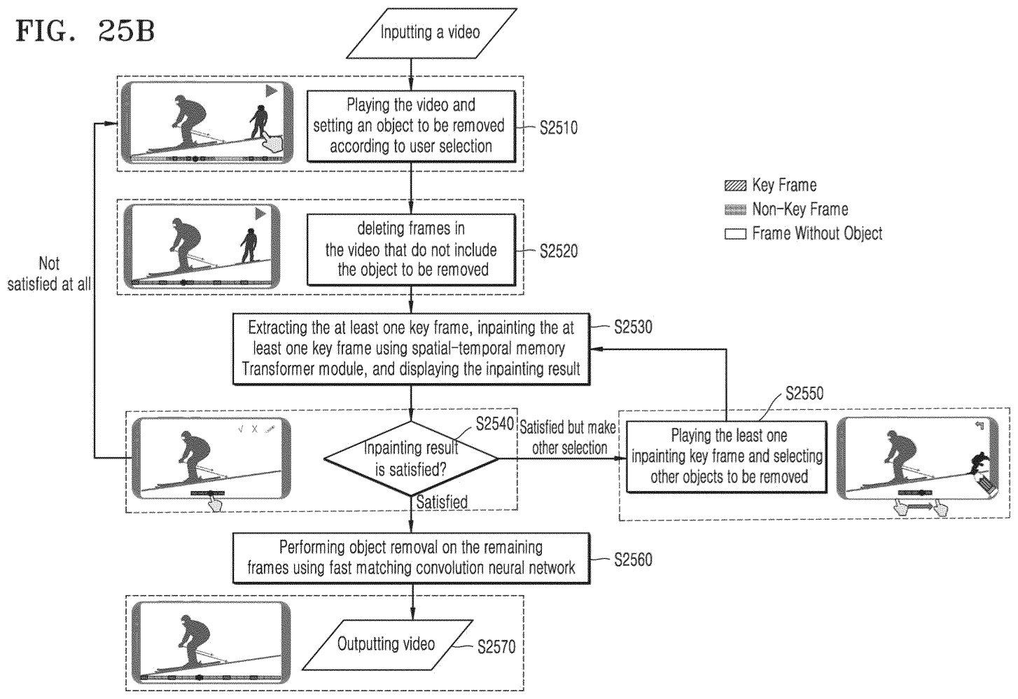

An example of the method performed by the electronic apparatus illustrated in FIG. 24 will be described in detail below with reference to FIGS. 25a and 25b.

FIG. 25A is a flowchart illustrating an example of applying a method performed by an electronic apparatus according to an embodiment of the disclosure.

As shown in FIG. 25A, at step S2410, a video is played on a display, and the object to be removed is set based on user selection, e.g., a target area to be removed is selected in the displayed video based on the user selection.

At step S2420, a at least one key frame and a at least one non-key frame are extracted from the video (e.g., step S110), and the at least one key frame is inpainted according to the above method proposed in the embodiment of the disclosure (e.g., step S120). For example, the object to be removed in the at least one key frame is removed utilizing a spatial-temporal memory Transformer module, and the at least one key frame in which the object to be removed is removed is displayed on the display.

At step S2430, whether a removal effect of the object to be removed in the at least one key frame satisfies a user requirement is determined according to a user input. According to this step, key frames on which the inpainting has been performed (e.g., the key frames in which the objects to be removed are removed) may be quickly shown to the user.

If it is determined that the removal effect of the object to be removed in the at least one key frames does not satisfy the user requirement at step S2430, e.g., a re-inpainting instruction input by the user is received, it returns to step S2410 to reset an object to be removed, e.g., an object to be removed (e.g., a target inpainting area) in the video is redetermined and step S2420 is performed.

If it is determined, at step S2430, that the removal effect of the object to be removed in the at least one key frame satisfies the user requirement but a request for removal of other objects (e.g., other target inpainting areas) is received from the user when the at least one inpainted key frame is played (for example, a setting instruction for setting the other target inpainting areas input by the user is received), at step S2440, the at least one inpainted key frame is played and the other objects to be removed are further set in the at least one inpainted key frame according to the user selection, and then it returns to step S2420, the other objects to be removed are further removed on the at least one key frame on which object removal is previously performed, and then it proceeds to step S2430 until the user is satisfied.

If it is determined that the removal effect of the objects to be removed in the at least one key frame satisfies the user requirement at step S2430 (for example, a continue inpainting instruction input by the user is received), it proceeds to step S2450 to inpaint non-key frames based on the at least one inpainted key frame (for example, to remove all the objects to be removed), e.g., to perform object removal on the remaining frames using the fast matching convolution neural network as proposed in the embodiment of the disclosure. Finally, at step S2460, the inpainted video is output.

FIG. 25B is a flowchart illustrating an example of applying a method performed by an electronic apparatus according to an embodiment of the disclosure.

As shown in FIG. 25B, at step S2510, a video is played on a display, and the object to be removed is set based on user selection, e.g., a target area to be removed is selected in the displayed video based on the user selection.

At step S2520, the video is preprocessed to remove frames in the video that do not include the object to be removed, e.g., frames that do not include the target inpainting area are removed from the video to be processed. By this pre-processing, the number of frames to be processed may be reduced, thereby improving the operation efficiency.

At step S2530, the at least one key frame and the at least one non-key frame are extracted from the preprocessed video (e.g., step S110), and the at least one key frame is inpainted according to the above-described method proposed in the embodiment of the disclosure (e.g., step S120), e.g., the object to be removed in the at least one key frame is removed utilizing the spatial-temporal memory Transformer module, and the at least one key frame in which the object to be removed is removed is displayed on the display.

At step S2540, whether a removal effect of the object to be removed in the at least one key frame satisfies a user requirement (e.g., whether the inpaint result is satisfied) is determined according to a user input.

If it is determined that the removal effect of the object to be removed in at least one key frame does not satisfy the user requirement at step S2540, e.g., a re-inpainting instruction input by the user is received, it returns to step S2510 to reset an object to be removed, e.g., an object to be removed in the video (e.g., a target inpainting area) is re-determined and step S2520 is performed.

If it is determined, at step S2540, that the removal effect of the object to be removed in the at least one key frame satisfies the user requirement but a request for removal of other objects is received from the user when the at least one inpainted key frame is played (for example, a setting instruction for setting the other target inpainting areas input by the user is received), at step S2550, the at least one inpainted key frame is played, and the other objects to be removed are further set in the at least one inpainted key frame according to the user selection, and then it returns to step S2530, the other objects to be removed are further removed on the at least one key frame on which object removal is previously performed, and then it proceeds to step S2540 until the user is satisfied.

If it is determined at step S2540 that the removal effect of the objects to be removed in the at least one key frame satisfies the user requirement (for example, a continue inpainting instruction input by the user is received), it proceeds to step S2560 to inpaint non-key frames based on the at least one inpainted key frame (for example, to remove the objects to be removed in all non-key frames), e.g., to perform object removal on the remaining frames using the fast matching convolution neural network as proposed in the embodiment of the disclosure. Finally, at step S2570, the inpainted video is output.

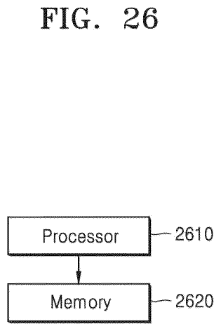

FIG. 26 is a block diagram illustrating an electronic apparatus 2600 according to an embodiment of the disclosure.

As shown in FIG. 26, the electronic apparatus 2600 includes at least one processor 2610 and at least one memory 2620 may store computer executable instructions, the computer executable instructions, when being executed by the at least one processor 2610, cause the at least one processor 2610 to perform the method performed by the electronic apparatus as described above.

The method performed by the electronic apparatus proposed in the embodiment of the disclosure realizes object removal in a video through two stages, firstly, in a first stage, objects to be removed in key frames are removed so as to obtain the inpainted key frames (for example, performing object removal on a few of key frames by a spatial-temporal memory Transformer module); then, in a second stage, non-key frames are inpainted according to the inpainted key frames obtained in the first stage (for example, performing object removal the non-key frames by a fast matching convolution neural network). This may improve a quality of image inpainting and solve problems of a low efficiency, an excessive resource consumption, a slow processing speed, a difficulty in processing a long video and an unstable complementary effect in the related art. At least one of the above plurality of modules may be implemented through the AI model. Functions associated with AI may be performed by a non-volatile memory, a volatile memory, and processors.

As an example, the electronic apparatus may be a PC computer, a tablet device, a personal digital assistant, a smart phone, or other devices capable of executing the above set of instructions. Here, the electronic apparatus does not have to be a single electronic apparatus and may also be any device or a collection of circuits that may execute the above instructions (or instruction sets) individually or jointly. The electronic apparatus may also be a part of an integrated control system or a system manager, or may be configured as a portable electronic apparatus interconnected by an interface with a local or remote (e.g., via wireless transmission). A processor may include one or more processors. At this time, the one or more processors may be a general-purpose processor, such as a central processing unit (CPU), an application processor (AP), etc., and a processor used only for graphics (such as, a graphics processing unit (GPU), a visual processing unit (VPU), and/or an AI dedicated processor (such as, a neural processing unit (NPU)). The one or more processors control the processing of input data according to predefined operation rules or AI models stored in a non-volatile memory and a volatile memory. The predefined operation rules or AI models may be provided through training or learning. Here, providing by learning means that the predefined operation rules or AI models with desired characteristics is formed by applying a learning algorithm to a plurality of learning data. The learning may be performed in the apparatus itself executing AI according to the embodiment, and/or may be implemented by a separate server/apparatus/system.

A learning algorithm is a method that uses a plurality of learning data to train a predetermined target apparatus (for example, a robot) to enable, allow, or control the target apparatus to make a determination or prediction. Examples of the learning algorithm include, but are not limited to, supervised learning, unsupervised learning, semi supervised learning, or reinforcement learning.

The AI models may be obtained through training. Here, “obtained through training” refers to training a basic AI model with a plurality of training data through a training algorithm to obtain the predefined operation rules or AI models, which are configured to perform the desired features (or purposes).

As an example, the AI models may include a plurality of neural network layers. Each of the plurality of neural network layers includes a plurality of weight values, and a neural network calculation is performed by performing a calculation between the calculation results of the previous layer and the plurality of weight values. Examples of the neural network include, but are not limited to, a convolution neural network (CNN), a depth neural network (DNN), a recurrent neural network (RNN), a restricted Boltzmann machine (RBM), a depth confidence network (DBN), a bidirectional recursive depth neural network (BRDNN), a generative countermeasure network (GAN), and a depth Q network.

The processor may execute instructions or codes stored in the memory, wherein the memory may also store data. The instructions and data may also be transmitted and received through a network via a network interface device, wherein the network interface device may use any known transmission protocol.

The memory may be integrated with the processor as a whole, for example, RAM or a flash memory is arranged in an integrated circuit microprocessor or the like. In addition, the memory may include an independent device, such as an external disk drive, a storage array, or other storage device that may be used by any database system. The memory and the processor may be operatively coupled, or may communicate with each other, for example, through an I/O port, a network connection, or the like, so that the processor may read files stored in the memory.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

According to an embodiment of the embodiment of the disclosure, there may also be provided a non-transitory computer-readable storage medium storing instructions, wherein the instructions, when being executed by at least one processor, cause the at least one processor to execute the above method performed by the electronic apparatus according to one or more embodiments of the disclosure. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as multimedia card, secure digital (SD) card or extremely fast digital (XD) card), magnetic tape, floppy disk, magneto-optical data storage device, optical data storage device, hard disk, solid state disk and any other devices which are configured to store computer programs and any associated data, data files, and data structures in a non-transitory manner, and provide the computer programs and any associated data, data files, and data structures to the processor or the computer, so that the processor or the computer may execute the computer programs. The instructions and the computer programs in the above computer-readable storage mediums may run in an environment deployed in computer equipment such as a client, a host, an agent device, a server, etc. In addition, in one example, the computer programs and any associated data, data files and data structures are distributed on networked computer systems, so that computer programs and any associated data, data files, and data structures are stored, accessed, and executed in a distributed manner through one or more processors or computers.

It should be noted that the terms “first”, “second”, “third”, “fourth”, “1”, “2” and the like (if exists) in the description and claims of the embodiment of the disclosure and the above drawings are used to distinguish similar objects, and need not be used to describe a specific order or sequence. It should be understood that data used as such may be interchanged in appropriate situations, so that the embodiments of the present application described here may be implemented in an order other than the illustration or text description.

It should be understood that although each operation step is indicated by arrows in the flowcharts of the embodiments of the present application, an implementation order of these steps is not limited to an order indicated by the arrows. Unless explicitly stated herein, in some implementation scenarios of the embodiments of the present application, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to requirements, which is not limited by the embodiment of the present application.

While the disclosure has been particularly shown and described with reference to embodiments thereof, it will be understood that various changes in form and details may be made therein without departing from the spirit and scope of the following claims.

According to an embodiment of the disclosure, a method performed by an electronic apparatus may include extracting the at least one key frame and the at least one non-key frame from the video based on decoding information of the video.

According to an embodiment of the disclosure, a method performed by an electronic apparatus may include extracting at least one frame from the video based on the decoding information of the video. According to an embodiment of the disclosure, a method performed by an electronic apparatus may include identifying the at least one key frame from the extracted frame based on a predetermined frame interval.

According to an embodiment of the disclosure, a method performed by an electronic apparatus may include inpainting each group of a plurality of groups of key frames. According to an embodiment of the disclosure, a method performed by an electronic apparatus may include extracting a feature of a group of key frames, among the plurality of groups, to be inpainted. According to an embodiment of the disclosure, a method performed by an electronic apparatus may include processing the extracted feature based on at least one of a first feature related to all of the plurality of groups of inpainted key frames or a second feature related to a previous group of inpainted key frames. According to an embodiment of the disclosure, a method performed by an electronic apparatus may include decoding the group of key frames based on the processed feature.

According to an embodiment of the disclosure, a method performed by an electronic apparatus may include extracting a third feature from the processed feature based on semantic correlation. According to an embodiment of the disclosure, a method performed by an electronic apparatus may include fusing the third feature with the first feature. According to an embodiment of the disclosure, a method performed by an electronic apparatus may include storing a fusion result as an updated first feature.

According to an embodiment of the disclosure, a method performed by an electronic apparatus may include updating the second feature based on the processed feature.

According to an embodiment of the disclosure, a method performed by an electronic apparatus may include processing the extracted feature based on a group of masks corresponding to the group of key frames, to obtain a roughly restored feature of the one group of key frames. According to an embodiment of the disclosure, a method performed by an electronic apparatus may include processing the roughly restored feature of the group of key frames based on the first feature, to obtain the processed roughly restored feature. According to an embodiment of the disclosure, a method performed by an electronic apparatus may include concatenating the second feature with the processed roughly restored feature to obtain the concatenated feature. According to an embodiment of the disclosure, a method performed by an electronic apparatus may include obtaining a final refined feature by processing the concatenated feature.

According to an embodiment of the disclosure, a method performed by an electronic apparatus may include obtaining a group of fourth features by splitting the roughly restored feature of the group of key frames in a time dimension, each fourth feature of the group of fourth features corresponding to one key frame in the group of key frames. According to an embodiment of the disclosure, a method performed by an electronic apparatus may include, for each fourth feature of the group of fourth features, extracting, from the first feature, a fifth feature with respect to an area corresponding to an object to be removed. According to an embodiment of the disclosure, a method performed by an electronic apparatus may include obtaining the processed roughly restored feature, by concatenating the fifth features extracted for each fourth feature of the group of fourth features and adding a concatenation result of the concatenating the fifth features to the roughly restored feature of the group of key frames.

According to an embodiment of the disclosure, a method performed by an electronic apparatus may include flattening tokens of one fourth feature of the group of fourth features and the first feature, respectively. According to an embodiment of the disclosure, a method performed by an electronic apparatus may include determining a similarity matrix for the one flattened fourth feature and the flattened first feature. According to an embodiment of the disclosure, a method performed by an electronic apparatus may include obtaining a weight matrix by normalizing the similarity matrix. According to an embodiment of the disclosure, a method performed by an electronic apparatus may include obtaining the fifth feature with respect to the area corresponding to the object to be removed, according to the first feature and the weight matrix.

According to an embodiment of the disclosure, a method performed by an electronic apparatus may include obtaining a group of sixth features by splitting the processed feature of the group of key frames in a time dimension, each sixth feature of the group of sixth features corresponding to one key frame of the one group of key frames. According to an embodiment of the disclosure, a method performed by an electronic apparatus may include updating the second feature, by processing the group of sixth features using a neural network formed by at least one cascaded Gate Recurrent Unit (GRU) module.

According to an embodiment of the disclosure, a method performed by an electronic apparatus may include obtaining a group of seventh features by splitting the processed feature of the one group of key frames in a time dimension, each seventh feature of the group of seventh features corresponding to one key frame of the group of key frames. According to an embodiment of the disclosure, a method performed by an electronic apparatus may include obtaining a group of eighth features by performing feature compression on each seventh feature of the group of seventh features in a spatial dimension. According to an embodiment of the disclosure, a method performed by an electronic apparatus may include obtaining the third feature by performing feature compression on a concatenation result of the group of eighth features in the time dimension.

According to an embodiment of the disclosure, a method performed by an electronic apparatus may include, for each seventh feature, performing the following operations to obtain one eighth feature. According to an embodiment of the disclosure, a method performed by an electronic apparatus may include flattening tokens of one seventh feature. According to an embodiment of the disclosure, a method performed by an electronic apparatus may include obtaining a ninth feature corresponding to the one seventh feature by, for each token in the one seventh feature, calculating similarity matrices between each token in the one seventh feature, and fusing tokens based on the similarity matrices. According to an embodiment of the disclosure, a method performed by an electronic apparatus may include obtaining a tenth feature corresponding to the one seventh feature, by performing fully connection on tokens of the ninth feature. According to an embodiment of the disclosure, a method performed by an electronic apparatus may include obtaining the one eighth feature by rearranging the tenth feature.

According to an embodiment of the disclosure, a method performed by an electronic apparatus may include flattening tokens of the concatenation result of the group of eighth features. According to an embodiment of the disclosure, a method performed by an electronic apparatus may include obtaining an eleventh feature corresponding to the concatenation result of the group of eighth features. According to an embodiment of the disclosure, a method performed by an electronic apparatus may include, for each token in the concatenation result of the group of eighth features, calculating similarity matrices between each token in the concatenation result of the group of eighth features. According to an embodiment of the disclosure, a method performed by an electronic apparatus may include fusing tokens based on the similarity matrices. According to an embodiment of the disclosure, a method performed by an electronic apparatus may include obtaining a twelfth feature corresponding to the concatenation result of the group of eighth features, by performing fully connection on tokens of the eleventh feature. According to an embodiment of the disclosure, a method performed by an electronic apparatus may include obtaining the third feature by rearranging the twelfth feature.

According to an embodiment of the disclosure, a method performed by an electronic apparatus may include inpainting each of the at least one non-key frame. According to an embodiment of the disclosure, a method performed by an electronic apparatus may include obtaining at least one aligned first key frame by aligning at least one first key frame related to a current non-key frame to the current non-key frame. According to an embodiment of the disclosure, a method performed by an electronic apparatus may include inpainting the current non-key frame based on the at least one aligned first key frame.

According to an embodiment of the disclosure, a method performed by an electronic apparatus may include, for each first key frame, obtaining the one aligned first key frame based on motion vector information of the current non-key frame relative to the one first key frame, to obtain one aligned first key frame.

According to an embodiment of the disclosure, at least one processor may be configured to extract the at least one key frame and the at least one non-key frame from the video based on decoding information of the video. According to an embodiment of the disclosure, at least one processor may be configured to extract at least one frame from the video based on the decoding information of the video. According to an embodiment of the disclosure, at least one processor may be configured to identify the at least one key frame from the extracted frame based on a predetermined frame interval.

According to an embodiment of the disclosure, at least one processor may be configured to extract a feature of a group of key frames, among the plurality of groups, to be inpainted. According to an embodiment of the disclosure, at least one processor may be configured to process the extracted feature based on at least one of a first feature related to all of the plurality of groups of inpainted key frames or a second feature related to a previous group of inpainted key frames. According to an embodiment of the disclosure, at least one processor may be configured to decode the group of key frames based on the processed feature.

According to an embodiment of the disclosure, at least one processor may be configured to extract a third feature from the processed feature based on semantic correlation. According to an embodiment of the disclosure, at least one processor may be configured to fuse the third feature with the first feature. According to an embodiment of the disclosure, at least one processor may be configured to store a fusion result as an updated first feature.

According to an embodiment of the disclosure, at least one processor may be configured to update the second feature based on the processed feature.

According to an embodiment of the disclosure, at least one processor may be configured to process the extracted feature based on a group of masks corresponding to the group of key frames, to obtain a roughly restored feature of the one group of key frames. According to an embodiment of the disclosure, at least one processor may be configured to process the roughly restored feature of the group of key frames based on the first feature, to obtain the processed roughly restored feature. According to an embodiment of the disclosure, at least one processor may be configured to concatenate the second feature with the processed roughly restored feature to obtain the concatenated feature. According to an embodiment of the disclosure, at least one processor may be configured to obtain a final refined feature by processing the concatenated feature.

According to an embodiment of the disclosure, at least one processor may be configured to obtain a group of fourth features by splitting the roughly restored feature of the group of key frames in a time dimension, each fourth feature of the group of fourth features corresponding to one key frame in the group of key frames. According to an embodiment of the disclosure, at least one processor is configured to, for each fourth feature of the group of fourth features, extract, from the first feature, a fifth feature with respect to an area corresponding to an object to be removed. According to an embodiment of the disclosure, at least one processor may be configured to obtain the processed roughly restored feature, by concatenating the fifth features extracted for each fourth feature of the group of fourth features and adding a concatenation result of the concatenating the fifth features to the roughly restored feature of the group of key frames.

According to an embodiment of the disclosure, at least one processor may be configured to flatten tokens of one fourth feature of the group of fourth features and the first feature, respectively. According to an embodiment of the disclosure, at least one processor may be configured to determine a similarity matrix for the one flattened fourth feature and the flattened first feature. According to an embodiment of the disclosure, at least one processor may be configured to obtain a weight matrix by normalizing the similarity matrix. According to an embodiment of the disclosure, at least one processor may be configured to obtain the fifth feature with respect to the area corresponding to the object to be removed, according to the first feature and the weight matrix.

According to an embodiment of the disclosure, at least one processor may be configured to obtain a group of sixth features by splitting the processed feature of the group of key frames in a time dimension, each sixth feature of the group of sixth features corresponding to one key frame of the one group of key frames. According to an embodiment of the disclosure, at least one processor may be configured to update the second feature, by processing the group of sixth features using a neural network formed by at least one cascaded Gate Recurrent Unit (GRU) module.

According to an embodiment of the disclosure, at least one processor may be configured to obtain a group of seventh features by splitting the processed feature of the one group of key frames in a time dimension, each seventh feature of the group of seventh features corresponding to one key frame of the group of key frames. According to an embodiment of the disclosure, at least one processor may be configured to obtain a group of eighth features by performing feature compression on each seventh feature of the group of seventh features in a spatial dimension. According to an embodiment of the disclosure, at least one processor may be configured to obtain the third feature by performing feature compression on a concatenation result of the group of eighth features in the time dimension.

According to an embodiment of the disclosure, at least one processor is configured to, for each seventh feature, perform the following operations to obtain one eighth feature. According to an embodiment of the disclosure, at least one processor may be configured to flatten tokens of one seventh feature. According to an embodiment of the disclosure, at least one processor may be configured to obtain a ninth feature corresponding to the one seventh feature by, for each token in the one seventh feature, calculating similarity matrices between each token in the one seventh feature, and fusing tokens based on the similarity matrices. According to an embodiment of the disclosure, at least one processor may be configured to obtain a tenth feature corresponding to the one seventh feature, by performing fully connection on tokens of the ninth feature. According to an embodiment of the disclosure, at least one processor may be configured to obtain the one eighth feature by rearranging the tenth feature.

According to an embodiment of the disclosure, at least one processor may be configured to flatten tokens of the concatenation result of the group of eighth features. According to an embodiment of the disclosure, at least one processor may be configured to obtain an eleventh feature corresponding to the concatenation result of the group of eighth features. According to an embodiment of the disclosure, at least one processor is configured to, for each token in the concatenation result of the group of eighth features, calculate similarity matrices between each token in the concatenation result of the group of eighth features, and fusing tokens based on the similarity matrices. According to an embodiment of the disclosure, at least one processor may be configured to obtain a twelfth feature corresponding to the concatenation result of the group of eighth features, by performing fully connection on tokens of the eleventh feature. According to an embodiment of the disclosure, at least one processor may be configured to obtain the third feature by rearranging the twelfth feature.

According to an embodiment of the disclosure, at least one processor may be configured to obtain at least one aligned first key frame by aligning at least one first key frame related to a current non-key frame to the current non-key frame. According to an embodiment of the disclosure, at least one processor may be configured to inpaint the current non-key frame based on the at least one aligned first key frame. According to an embodiment of the disclosure, at least one processor is configured to, for each first key frame, obtain the one aligned first key frame based on motion vector information of the current non-key frame relative to the one first key frame, to obtain one aligned first key frame.

According to an embodiment of the disclosure, at least one processor may be configured to determine a target inpainting area in a first video. According to an embodiment of the disclosure, at least one processor may be configured to inpaint the target inpainting area in key frames of the first video using a first neural network. According to an embodiment of the disclosure, at least one processor may be configured to display a second video containing the inpainted key frames. According to an embodiment of the disclosure, at least one processor may be configured to receive a continue inpainting instruction input by a user. According to an embodiment of the disclosure, at least one processor is configured to, based on the continue inpainting instruction, use a second neural network to inpaint the target inpainting area in non-key frames of the first video based on the inpainted key frames, to generate an inpainted first video. According to an embodiment of the disclosure, at least one processor may be configured to display the inpainted first video.

According to an embodiment of the disclosure, at least one processor may be configured to receive a re-inpainting instruction input by the user, after the displaying the second video. According to an embodiment of the disclosure, at least one processor may be configured to re-determine a target inpainting area in the first video according to the re-inpainting instruction. According to an embodiment of the disclosure, at least one processor may be configured to inpaint the re-determined target inpainting area in the key frames of the first video using the first neural network.

According to an embodiment of the disclosure, at least one processor may be configured to receive a setting instruction for setting other target inpainting areas input by the user, after displaying the second video. According to an embodiment of the disclosure, at least one processor may be configured to determine the other target inpainting areas in the inpainted key frames according to the setting instruction. According to an embodiment of the disclosure, at least one processor may be configured to inpaint the other target inpainting areas in the inpainted key frames using the first neural network.

What is claimed is:

1. A method performed by an electronic apparatus, the method comprising:
extracting at least one key frame and at least one non-key frame from a video;
inpainting the at least one key frame based on at least one mask corresponding to the at least one key frame; and
inpainting the at least one non-key frame based on the at least one inpainted key frame.

2. The method according to claim 1, wherein the extracting the at least one key frame and the at least one non-key frame from the video comprises extracting the at least one key frame and the at least one non-key frame from the video based on decoding information of the video.

3. The method according to claim 2, wherein the extracting the at least one key frame from the video based on the decoding information of the video comprises:
extracting at least one frame from the video based on the decoding information of the video; and
identifying the at least one key frame from the extracted frame based on a predetermined frame interval.

4. The method according to claim 1, wherein the inpainting the at least one key frame based on the at least one mask corresponding to the at least one key frame comprises inpainting each group of a plurality of groups of key frames by:
extracting a feature of a group of key frames, among the plurality of groups, to be inpainted;
processing the extracted feature based on at least one of a first feature related to all of the plurality of groups of inpainted key frames or a second feature related to a previous group of inpainted key frames; and
decoding the group of key frames based on the processed feature.

5. The method according to claim 4, further comprising:
extracting a third feature from the processed feature based on semantic correlation;
fusing the third feature with the first feature; and
storing a fusion result as an updated first feature.

6. The method according to claim 4, further comprising:
updating the second feature based on the processed feature.

7. The method according to claim 4, wherein the processing the extracted feature comprises:
processing the extracted feature based on a group of masks corresponding to the group of key frames, to obtain a roughly restored feature of the one group of key frames;
processing the roughly restored feature of the group of key frames based on the first feature, to obtain the processed roughly restored feature;
concatenating the second feature with the processed roughly restored feature to obtain the concatenated feature; and
obtaining a final refined feature by processing the concatenated feature.

8. The method according to claim 7, wherein the processing the roughly restored feature of the group of key frames based on the first feature, to obtain the processed roughly restored feature, comprises:
obtaining a group of fourth features by splitting the roughly restored feature of the group of key frames in a time dimension, each fourth feature of the group of fourth features corresponding to one key frame in the group of key frames;
for each fourth feature of the group of fourth features, extracting, from the first feature, a fifth feature with respect to an area corresponding to an object to be removed; and
obtaining the processed roughly restored feature, by concatenating the fifth features extracted for each fourth feature of the group of fourth features and adding a concatenation result of the concatenating the fifth features to the roughly restored feature of the group of key frames.

9. The method according to claim 8, wherein, for each fourth feature of the group of fourth features, the extracting, from the first feature, the fifth feature with respect to the area corresponding to the object to be removed, comprises:
flattening tokens of one fourth feature of the group of fourth features and the first feature, respectively;
determining a similarity matrix for the one flattened fourth feature and the flattened first feature;
obtaining a weight matrix by normalizing the similarity matrix; and
obtaining the fifth feature with respect to the area corresponding to the object to be removed, according to the first feature and the weight matrix.

10. The method according to claim 6, wherein the updating the second feature based on the processed feature comprises:
obtaining a group of sixth features by splitting the processed feature of the group of key frames in a time dimension, each sixth feature of the group of sixth features corresponding to one key frame of the one group of key frames; and
updating the second feature, by processing the group of sixth features using a neural network formed by at least one cascaded Gate Recurrent Unit (GRU) module.

11. The method according to claim 5, wherein the extracting the third feature from the processed feature based on the semantic correlation comprises:
obtaining a group of seventh features by splitting the processed feature of the one group of key frames in a time dimension, each seventh feature of the group of seventh features corresponding to one key frame of the group of key frames;
obtaining a group of eighth features by performing feature compression on each seventh feature of the group of seventh features in a spatial dimension; and
obtaining the third feature by performing feature compression on a concatenation result of the group of eighth features in the time dimension.

12. The method according to claim 11, wherein the obtaining the group of eighth features by performing feature compression on each seventh feature of the group of seventh features in the spatial dimension comprises: for each seventh feature, performing the following operations to obtain one eighth feature:
flattening tokens of one seventh feature;
obtaining a ninth feature corresponding to the one seventh feature by, for each token in the one seventh feature, calculating similarity matrices between each token in the one seventh feature, and fusing tokens based on the similarity matrices;
obtaining a tenth feature corresponding to the one seventh feature, by performing fully connection on tokens of the ninth feature; and
obtaining the one eighth feature by rearranging the tenth feature.

13. The method according to claim 11, wherein the obtaining the third feature by performing the feature compression on the concatenation result of the group of eighth features in the time dimension comprises:
flattening tokens of the concatenation result of the group of eighth features;
obtaining an eleventh feature corresponding to the concatenation result of the group of eighth features by: for each token in the concatenation result of the group of eighth features, calculating similarity matrices between each token in the concatenation result of the group of eighth features, and fusing tokens based on the similarity matrices;
obtaining a twelfth feature corresponding to the concatenation result of the group of eighth features, by performing fully connection on tokens of the eleventh feature; and
obtaining the third feature by rearranging the twelfth feature.

14. The method according to claim 1, wherein the inpainting the at least one non-key frame based on the at least one inpainted key frame comprises inpainting each of the at least one non-key frame by:
obtaining at least one aligned first key frame by aligning at least one first key frame related to a current non-key frame to the current non-key frame; and
inpainting the current non-key frame based on the at least one aligned first key frame.

15. The method according to claim 14, wherein the obtaining the at least one aligned first key frame comprises:
for each first key frame, obtaining the one aligned first key frame based on motion vector information of the current non-key frame relative to the one first key frame, to obtain one aligned first key frame.

16. An electronic apparatus comprising:
at least one processor; and
at least one memory storing computer executable instructions that, when executed by the at least one processor, cause the at least one processor configured to:
extract at least one key frame and at least one non-key frame from a video;
inpaint the at least one key frame based on at least one mask corresponding to the at least one key frame; and
inpaint the at least one non-key frame based on the at least one inpainted key frame.

17. The electronic apparatus of claim 16, wherein the at least one processor further configured to:
extract the at least one key frame and the at least one non-key frame from the video based on decoding information of the video.

18. The electronic apparatus of claim 16, wherein the at least one processor further configured to:
extract a feature of a group of key frames, among the plurality of groups, to be inpainted;
process the extracted feature based on at least one of a first feature related to all of the plurality of groups of inpainted key frames or a second feature related to a previous group of inpainted key frames; and
decode the group of key frames based on the processed feature.

19. The electronic apparatus of claim 16, wherein the at least one processor further configured to:
obtain at least one aligned first key frame by aligning at least one first key frame related to a current non-key frame to the current non-key frame; and
inpaint the current non-key frame based on the at least one aligned first key frame.

20. A non-transitory computer readable storage medium storing instructions that, when executed by at least one processor, cause the at least one processor to perform the method according to claim 1.
